(19) United States
(12) Patent Application Publication
(10) Pub. No.: US 2014/0203994 A1
(43) Pub. Date: Jul. 24, 2014

(54) ANTENNA MODULE AND METHOD FOR MANUFACTURING THE SAME

(71) Applicant: Nitto Denko Corporation, Osaka (JP)

(72) Inventors: Masayuki HODONO, Osaka (JP); Masami INOUE, Osaka (JP); Mitsuru HONJO, Osaka (JP)

(73) Assignee: Nitto Denko Corporation, Osaka (JP)

(21) Appl. No.: 14/155,882

(22) Filed: Jan. 15, 2014

(30) Foreign Application Priority Data
Jan. 21, 2013 (JP) 2013-008654

(51) Int. Cl. H01Q 3/01

(52) U.S. Cl. CPC H01Q 3/01
USPC 343/878; 29/601

(57) ABSTRACT

An antenna module includes a support body and an antenna body. The support body has a flat support surface and a support surface that extends obliquely upward from one side of the support surface. The antenna body is attached to the support surface while being bent along the support surface of the support body. The antenna body is constituted by a dielectric film, a pair of electrodes and a semiconductor device. The pair of electrodes is formed on a main surface of the dielectric film, and the semiconductor device is mounted on the end of the electrode.

### BACKGROUND OF THE INVENTION

1. Field of the Invention

The present invention relates to an antenna module that transmits or receives an electromagnetic wave of a frequency in a terahertz band not less than 0.05 THz and not more than 10 THz, for example, and a method for manufacturing the antenna module.

2. Description of Related Art

Terahertz transmission using an electromagnetic wave in the terahertz band is expected to be applied to various purposes such as short-range super high speed communication and uncompressed delayless super high-definition video transmission.

A terahertz oscillation device using a semiconductor substrate is described in JP 2010-57161 A. In the terahertz oscillation device described in JP 2010-57161 A, first and second electrodes, an MIM (Metal Insulator Metal) reflector, a resonator and an active element are formed on the semiconductor substrate. A horn opening is arranged between the first electrode and the second electrode.

### BRIEF SUMMARY OF THE INVENTION

Because an antenna electrode is formed on the semiconductor substrate in the above-mentioned terahertz oscillation device, the radiation direction of the electromagnetic wave is determined by the shape of the antenna electrode, and the semiconductor substrate. Degree of freedom in arranging the terahertz oscillation device is limited due to a decrease in size and thickness of the electronic apparatuses. Therefore, it is difficult to set the transmission/reception direction of the electromagnetic wave to a desired direction without preventing a decrease in size and thickness of the electronic apparatuses.

An object of the present invention is to provide an antenna module in which a reception direction or a transmission direction can be set to a desired direction even if degree of freedom in arrangement is limited, and in which a transmission speed and a transmission distance can be improved, and a method for manufacturing the antenna module.

(1) According to one aspect of the present invention, an antenna module includes a dielectric film that has first and second surfaces and is formed of resin to be bendable, an electrode formed on at least one surface of the first and second surfaces of the dielectric film to be capable of receiving and transmitting an electromagnetic wave in a terahertz band, a semiconductor device that is mounted on at least one surface of the first and second surfaces of the dielectric film to be electrically connected to the electrode, and is operable in the terahertz band, and a support body that supports the dielectric film being bent.

The terahertz band indicates a range of frequencies of not less than 0.05 THz and not more than 10 THz, for example, and preferably indicates a range of frequencies of not less than 0.1 THz and not more than 1 THz.

In the antenna module, the electromagnetic wave in the terahertz band is received or transmitted by the electrode formed on at least one surface of the first and second surfaces of the dielectric film. Further, the semiconductor device mounted on at least one surface of the first and second surfaces of the dielectric film performs detection and rectification, or oscillation.

The dielectric film is formed of resin to be bendable. Thus, the orientation of the electrode on the dielectric film can be easily changed, so that the receipt direction or the transmission direction of the electromagnetic wave can be easily adjusted. Further, because the bent dielectric film is supported by the support body, the shape-retaining property of the dielectric film is ensured. Thus, the reception direction or the transmission direction of the electromagnetic wave can be fixed to an adjusted direction. Therefore, even if the degree of freedom in arranging the antenna module is limited, the reception direction or the transmission direction of the electromagnetic wave can be set to a desired direction.

Here, the dielectric film is formed of resin, so that an effective relative permittivity of the surroundings of the electrode is low. Thus, the electromagnetic wave radiated from the electrode or received by the electrode is less likely attracted to the dielectric film. Therefore, the electromagnetic wave can be efficiently radiated, and the better directivity of the antenna module is obtained.

Here, the transmission loss α [dB/m] of the electromagnetic wave is expressed in the following formula by a conductor loss α1 and a dielectric loss α2.

α=α1+α2 [dB/m]

Letting ∈_{ref} be an effective relative permittivity, f be a frequency, R(f) be conductor surface resistance and tan θ be a dielectric tangent, the conductor loss α1 and the dielectric loss α2 are expressed as below.

α1∝R(f)√∈_{ref} [dB/M]

α2∝√∈_{ref}·tan δ·f [dB/M]

From the above expressions, if the effective relative permittivity ∈_{ref} is low, the transmission loss α of the electromagnetic wave is reduced.

In the antenna module according to the present invention, because the effective relative permittivity of the surroundings of the electrode is low, the transmission loss of the electromagnetic wave is reduced. Thus, the transmission speed and the transmission distance can be improved.

(2) The support body may have a third surface, the dielectric film may include a first portion bonded to the third surface and a second portion bent with respect to the first portion, and at least part of the electrode is formed on the second portion.

In this case, the first portion of the dielectric film can be easily fixed to the third surface of the support body, and the second portion in which at least part of the electrode is formed can be directed in a desired direction. Thus, the reception direction or the transmission direction for the electromagnetic wave can be easily set to a desired direction.

(3) The support body may further have a fourth surface provided to be inclined by a predetermined angle with respect to the third surface, and the second portion of the dielectric film may be bonded to the fourth surface of the support body.

In this case, the first and second portions of the dielectric film can be reliably fixed to the support body while the second portion of the dielectric film is easily directed in a desired direction.

(4) The support body may further have a fourth surface provided to face away from the third surface, the dielectric film may further have a curved portion between the first portion and the second portion, and the second portion may be bonded to the fourth surface of the support body.

In this case, the first and second portions of the dielectric film can be reliably fixed to the support body while the second portion of the dielectric film is facing away from the first portion of the dielectric film.

(5) The electrode may be formed to extend on a first portion and a second portion.

In this case, in a portion of the electrode formed on the first portion and a portion of the electrode formed on the second portion, the electromagnetic waves can be transmitted in opposite directions, or the electromagnetic waves that arrive in opposite directions can be received.

(6) The dielectric film may further have a holder that holds the second portion at the support body such that a space is formed between the support body and the second portion.

In this case, the effect of the relative permittivity of the support body on the received or transmitted electromagnetic wave is reduced. Thus, the transmission loss of the electromagnetic wave is reduced, so that the antenna efficiency is improved.

(7) The holder of the dielectric film may include a third portion bent with respect to the second portion and a fourth portion bent with respect to the third portion, and the fourth portion may be bonded to the third surface of the support body such that a space is formed between the second portion and the support body.

In this case, the first portion and the fourth portion of the dielectric film can be reliably fixed to the support body while the effect of the relative permittivity of the support body on the received or transmitted electromagnetic wave is reduced.

Further, the distance between the first portion and the fourth portion is adjusted, whereby an angle of the second portion with the first portion can be easily set to a desired angle. Further, the dimensions of the antenna module can be easily adjusted.

(8) According to another aspect of the present invention, a method for manufacturing an antenna module includes the steps of forming a bendable dielectric film with resin, forming an electrode that is capable of receiving or transmitting an electromagnetic wave in a terahertz band on at least one surface of the first and second surfaces of the dielectric film, mounting a semiconductor device operable in the terahertz band on at least one surface of the first and second surfaces of the dielectric film to be electrically connected to the electrode, and bending the dielectric film that includes the electrode and the semiconductor device, and supporting the bent dielectric film by a support body.

In the method, the electrode is formed on at least one surface of the first and second surfaces of the dielectric film, and the semiconductor device is mounted on at least one surface of the first and second surfaces of the dielectric film. In this case, the electromagnetic wave in the terahertz band is received or transmitted by the electrode. Further, the semiconductor device performs detection and rectification, or oscillation.

The dielectric film that includes the electrode and the semiconductor device is bent. Thus, the orientation of the electrode on the dielectric film can be adjusted, so that the receipt direction or the transmission direction of the electromagnetic wave can be adjusted. Further, because the bent dielectric film is supported by the support body, the shape-retaining property of the dielectric film is ensured. Thus, the reception direction or the transmission direction of the electromagnetic wave can be fixed to an adjusted direction. Therefore, even if the degree of freedom in arranging the antenna module is limited, the reception direction or the transmission direction can be set to a desired direction.

Further, because the dielectric film is formed of resin, the effective relative permittivity of the surroundings of the electrode is reduced. Thus, the electromagnetic wave radiated from the electrode or the electromagnetic wave received by the electrode is less likely attracted to the dielectric film. Therefore, the electromagnetic wave can be efficiently radiated, and the better directivity of the antenna module is obtained. Further, because the effective relative permittivity of the surroundings of the electrode is low, the transmission loss of the electromagnetic wave is reduced. Thus, the transmission speed and the transmission distance can be improved.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is an external perspective view of an antenna module according to a first embodiment of the present invention;

FIG. 2 is a schematic side view of the antenna module of FIG. 1;

FIG. 3 is a schematic plan view of an antenna body;

FIG. 4 is a schematic cross sectional view of the antenna body;

FIG. 5 is a schematic diagram showing the mounting of a semiconductor device using a flip-tip mounting method;

FIG. 6 is a schematic diagram showing the mounting of the semiconductor device using a wire bonding mounting method;

FIG. 7 is a schematic plan view showing the reception operation of the antenna body according to the present embodiment;

FIG. 8 is a schematic plan view showing the transmission operation of the antenna body according to the present embodiment;

FIG. 9 is a schematic side view for explaining the directivity of the antenna body according to the present embodiment;

FIG. 10 is a schematic side view for explaining the change in directivity of the antenna body according to the present embodiment;

FIG. 11 is a schematic plan view for explaining the dimensions of the antenna body used for the simulation and the experiment;

FIG. 12 is a diagram showing the simulation results of the relation between the thickness of the dielectric film and the radiation efficiency at 300 GHz;

FIG. 13 is a diagram showing the simulation results of the relation between the relative permittivity of the dielectric film and the radiation efficiency at 300 GHz;

FIGS. 14(a) and 14(b) are diagrams showing the results of the three-dimensional electromagnetic field simulation obtained when the antenna module is not bent;

FIGS. 15(a) and 15(b) are diagrams showing the results of the three-dimensional electromagnetic field simulation obtained when the antenna module is bent;

FIG. 16 is a schematic diagram for explaining the definition of the reception angle of the antenna module by the simulation;

FIG. 17 is a diagram showing the calculation results of the antenna gain obtained when the antenna module is not bent, and when the antenna module is bent;

FIG. 18 is an external perspective view of the antenna module according to the second embodiment of the present invention;

FIG. 19 is a schematic side view of the antenna module of FIG. 18;

FIG. 20 is a schematic diagram for explaining the definition of the transmission/reception angle of the antenna module by the simulation;

FIG. 21 is a diagram showing the calculation results of the antenna gain obtained when a support body is not arranged;

FIG. 22 is a diagram showing the calculation results of the antenna gain obtained when porous PTFE is used as the material for the support body;

FIG. 23 is a diagram showing the calculation results of the antenna gain obtained when non-porous PTFE is used as the material for the support body;

FIG. 24 is a diagram showing the calculation results of the antenna gain [dBi] obtained when FR4 is used as the material for the support body;

FIG. 25 is an external perspective view of the antenna module according to the third embodiment of the present invention;

FIG. 26 is a schematic side view of the antenna module of FIG. 25;

FIG. 27 is a schematic diagram for explaining the definition of the transmission/reception angle of the antenna module by the simulation;

FIG. 28 is a diagram showing the calculation results of the antenna gain obtained when a bending angle φ is 0°;

FIG. 29 is a diagram showing the calculation results of the antenna gain obtained when the bending angle φ is 5°;

FIG. 30 is a diagram showing the calculation results of the antenna gain obtained when the bending angle φ is 10°;

FIG. 31 is a diagram showing the calculation results of the antenna gain obtained when the bending angle φ is 15°;

FIG. 32 is a diagram showing the calculation results of the antenna gain obtained when the bending angle φ is 30°;

FIG. 33 is a diagram showing the calculation results of the antenna gain obtained when the bending angle φ is 45°;

FIG. 34 is a diagram showing the relation between the bending angle φ and the maximum value of the antenna gain obtained when non-porous PTFE is used as the material for the support body;

FIG. 35 is a diagram showing the relation between the bending angle φ and the antenna gain obtained when FR4 is used as the material for the support body;

FIG. 36 is a diagram showing the results of the two-dimensional electromagnetic field simulation obtained when the bending angle φ is 0°;

FIG. 37 is a diagram showing the results of the two-dimensional electromagnetic field simulation obtained when the bending angle φ is 5°;

FIG. 38 is a diagram showing the results of the two-dimensional electromagnetic field simulation obtained when the bending angle φ is 10°;

FIG. 39 is a diagram showing the results of the two-dimensional electromagnetic field simulation obtained when the bending angle φ is 15°;

FIG. 40 is a diagram showing the results of the two-dimensional electromagnetic field simulation obtained when the bending angle is 30°;

FIG. 41 is a diagram showing the results of the two-dimensional electromagnetic field simulation obtained when the bending angle φ is 45°;

FIG. 42 is a diagram showing the results of the three-dimensional field electromagnetic field simulation obtained when the bending angle φ is 0°;

FIG. 43 is a diagram showing the results of the three-dimensional electromagnetic field simulation obtained when the bending angle φ is 5°;

FIG. 44 is a diagram showing the results of the three-dimensional electromagnetic field simulation obtained when the bending angle φ is 10°;

FIG. 45 is a diagram showing the results of the three-dimensional electromagnetic field simulation obtained when the bending angle φ is 15°;

FIG. 46 is a diagram showing the results of the three-dimensional electromagnetic field simulation obtained when the bending angle φ is 30°;

FIG. 47 is a diagram showing the results of the three-dimensional electromagnetic field simulation obtained when the bending angle φ is 45°;

FIG. 48 is a schematic plan view showing a modified example of the antenna body; and

FIG. 49 is a schematic side view of the antenna module according to a fourth embodiment.

### DESCRIPTION OF THE PREFERRED EMBODIMENTS

An antenna module and a method for manufacturing the antenna module according to embodiments of the present invention will be described below. In the following description, a frequency band from 0.05 THz to 10 THz is referred to as the terahertz band. The antenna module according to the embodiments can receive or transmit an electromagnetic wave having at least a specific frequency in the terahertz band.

### (1) First Embodiment

### (1-1) Configuration of Antenna Module

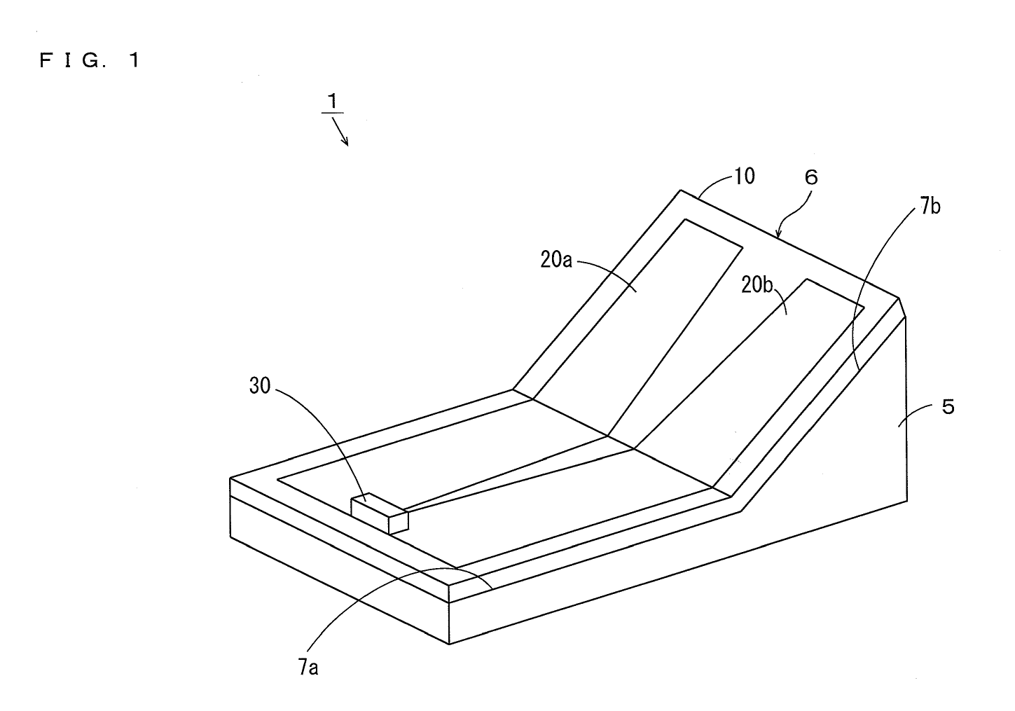

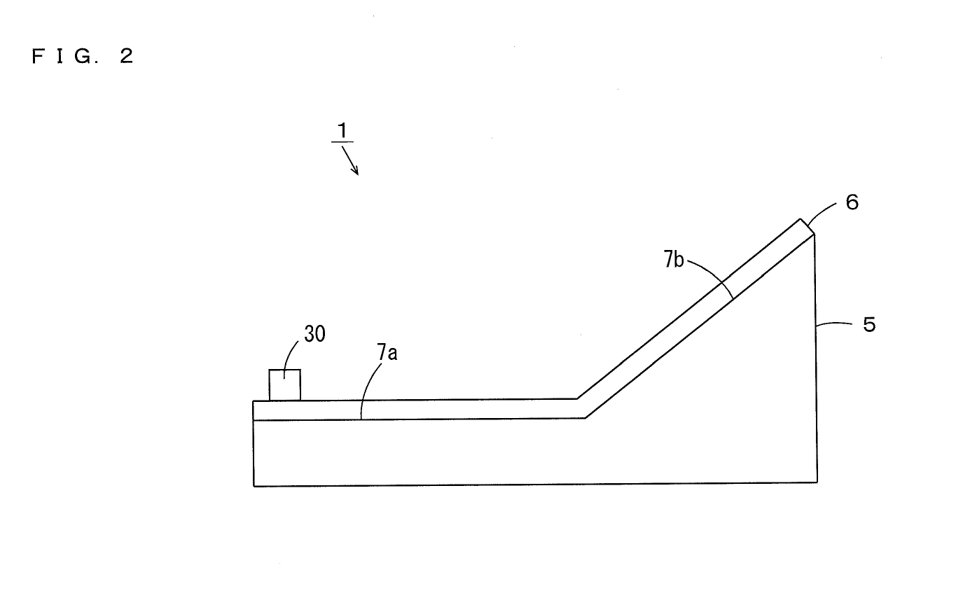

FIG. 1 is an external perspective view of the antenna module according to the first embodiment of the present invention. FIG. 2 is a schematic side view of the antenna module of FIG. 1.

In FIG. 1, the antenna module 1 includes a support body 5 and an antenna body 6. For example, polytetrafluoroethylene (PTFE), FR4 (glass epoxy) or porous PTFE which is a porous media of PTFE is used as material for the support body 5. The support body 5 preferably has a relative permittivity of not more than 3.0, and more preferably has a relative permittivity of not more than 2.0, in a used frequency within the terahertz band. FR4 has a relative permittivity of 4.2 in the terahertz band, and PTFE has a relative permittivity of 2.0 in the terahertz band.

The support body 5 has a flat support surface 7a and a support surface 7b that extends obliquely upward from one side of the support surface 7a. The support surface 7a is an example of a third surface of claim 2, and the support surface 7b is an example of a fourth surface of claim 3. The antenna body 6 is attached to the support surfaces 7a, 7b while being bent along the support surfaces 7a, 7b of the support body 5. A portion of the dielectric film 10 attached to the support surface 7a is an example of a first portion of claim 2, and a portion of the dielectric film 10 attached to the support surface 7b is an example of a second portion of claim 3.

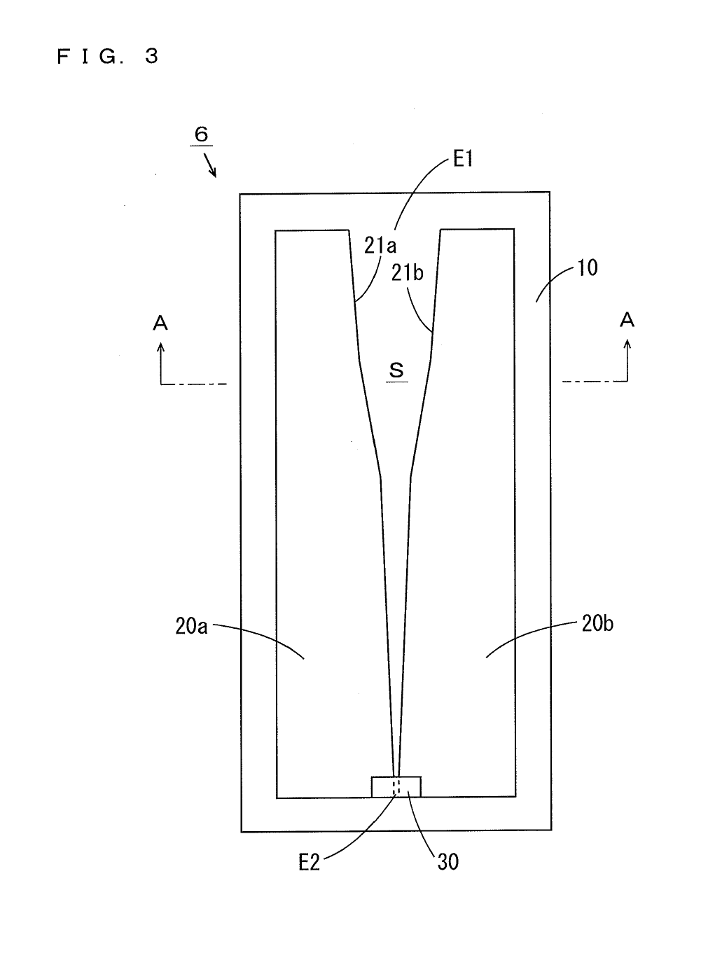

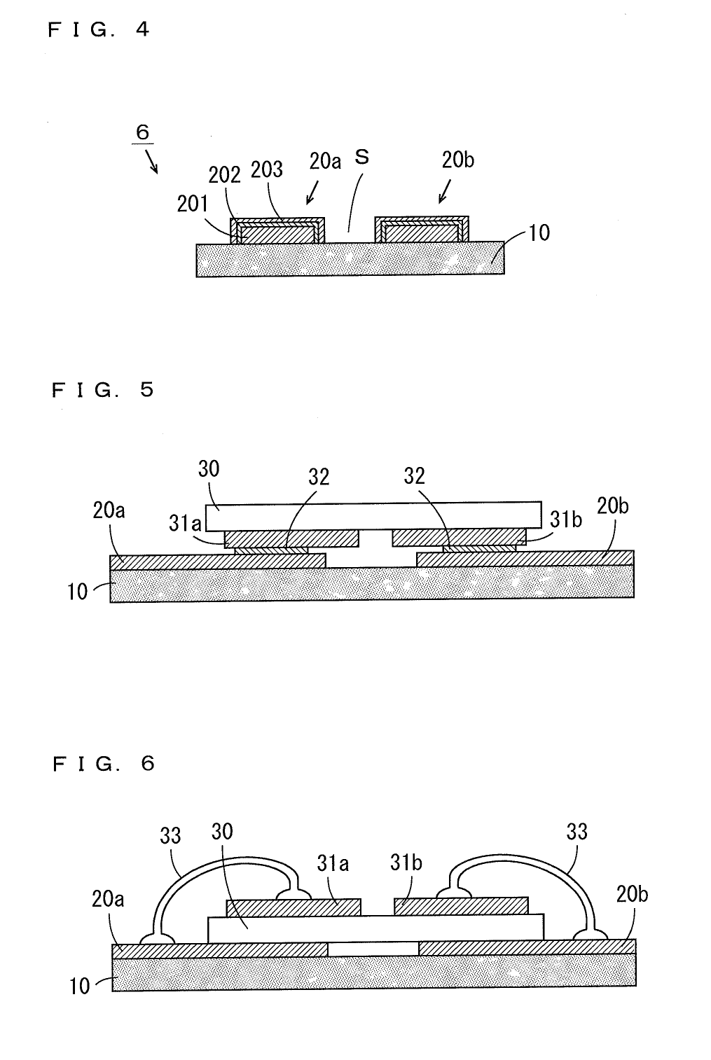

FIG. 3 is a schematic plan view of the antenna body 6. FIG. 4 is a schematic cross sectional view of the antenna body 6. In FIGS. 3 and 4, the antenna body 6 that is not bent is shown.

In FIGS. 3 and 4, the antenna body 6 is constituted by the dielectric film 10, the pair of electrodes 20a, 20b and the semiconductor device 30. The dielectric film 10 is formed of resin that is made of polymer. One surface of the two surfaces of the dielectric film 10 facing away from each other is referred to as a main surface, and the other surface is referred to as a back surface. In the present embodiment, the main surface is an example of a first surface, and the back surface is an example of a second surface.

The pair of electrodes 20a, 20b is formed on the main surface of the dielectric film 10. A gap that extends from one end to the other end of a set of the electrodes 20a, 20b is provided between the electrodes 20a, 20b. End surfaces 21a, 21b of the electrodes 20a, 20b that face each other are formed in a tapered shape such that the width of the gap continuously or gradually decreases from the one end to the other end of a set of the electrodes 20a, 20b. The gap between the electrodes 20a, 20b is referred to as a tapered slot S. The electrodes 20a, 20b constitute a tapered slot antenna. The dielectric film 10 and the electrodes 20a, 20b are formed of a flexible printed circuit board. In this case, the electrodes 20a, 20b are formed on the dielectric film 10 using a subtractive method, an additive method or a semi-additive method. If a below-mentioned semiconductor device 30 is appropriately mounted, the electrodes 20a, 20b may be formed on the dielectric film 10 using another method. For example, the electrodes 20a, 20b may be formed by patterning a conductive material on the dielectric film 10 using a screen printing method, an ink-jet method or the like.

Here, the dimension in the direction of a central axis of the tapered slot S is referred to as length, and the dimension in the direction parallel to the main surface of the dielectric film 10 and orthogonal to the central axis of the tapered slot S is referred to as width. The end of the tapered slot S having the maximum width is referred to as an opening end E1, and the end of the tapered slot S having the minimum width is referred to as a mount end E2. Further, a direction directed from the mount end E2 toward the opening end E1 of the antenna body 6 and extends along the central axis of the tapered slot S is referred to as a central axis direction.

The semiconductor device 30 is mounted on the ends of a set of the electrodes 20a, 20b at the mount end E2 using a flip chip mounting method or a wire bonding mounting method. One terminal of the semiconductor device 30 is electrically connected to the electrode 20a, and another terminal of the semiconductor device 30 is electrically connected to the electrode 20b. The mounting method of the semiconductor device 30 will be described below. The electrode 20b is to be grounded.

As the material for the dielectric film 10, one or more types of porous resins or non-porous resins out of polyimide, polyetherimide, polyamide-imide, polyolefin, cycloolefin polymer, polyarylate, polymethyl methacrylate polymer, liquid crystal polymer, polycarbonate, polyphenylene sulfide, polyether ether ketone, polyether sulfone, polyacetal, fluororesin, polyester, epoxy resin, polyurethane resin and urethane acrylic resin (acryl resin) can be used.

Fluororesin includes PTFE, polyvinylidene fluoride, ethylene-tetrafluoroethylene copolymer, perfluoro-alkoxy fluororesin, fluorinated ethylene-propylene copolymer (tetrafluoroethylene-hexafluoropropylene copolymer) or the like. Polyester includes polyethylene terephthalate, polyethylene naphthalate, polybutylene terephthalate or the like.

In the present embodiment, the dielectric film 10 is formed of polyimide.

The thickness of the dielectric film 10 is preferably not less than 1 μm and not more than 1000 μm. In this case, the dielectric film 10 can be easily fabricated and flexibility of the dielectric film 10 can be easily ensured. The thickness of the dielectric film 10 is more preferably not less than 5 μm and not more than 100 μm. In this case, the dielectric film 10 can be more easily fabricated and higher flexibility of the dielectric film 10 can be easily ensured. In the present embodiment, the thickness of the dielectric film 10 is 25 μm, for example.

The dielectric film 10 preferably has a relative permittivity of not more than 7.0, and more preferably has a relative permittivity of not more than 4.0, in a used frequency within the terahertz band. In this case, the radiation efficiency of an electromagnetic wave having the used frequency is sufficiently increased, and the transmission loss of the electromagnetic wave is sufficiently reduced. Thus, the transmission speed and the transmission distance of the electromagnetic wave having the used frequency can be sufficiently improved. In the present embodiment, the dielectric film 10 is formed of resin having a relative permittivity of not less than 1.2 and not more than 7.0 in the terahertz band. The relative permittivity of polyimide is about 3.2 in the terahertz band, and the relative permittivity of porous PTFE is about 1.2 in the terahertz band.

The electrodes 20a, 20b may be formed of a conductive material such as metal or an alloy, and may have single layer structure or laminate structure of a plurality of layers.

In the present embodiment, as shown in FIG. 4, each of the electrodes 20a, 20b has the laminate structure of a copper layer 201, a nickel layer 202 and a gold layer 203. The thickness of the copper layer 201 is 15 μm, for example, the thickness of the nickel layer 202 is 3 μm, for example and the thickness of the gold layer 203 is 0.2 μm, for example. The material and the thickness of the electrodes 20a, 20b are not limited to the examples of the present embodiment.

In the present embodiment, the laminate structure of FIG. 4 is adopted to perform the flip chip mounting by Au stud bumps and a wire bonding mounting by Au bonding wires, mentioned below. Formation of the nickel layer 202 and the gold layer 203 is surface processing for the copper layer 201 in a case in which the afore-mentioned mounting methods are used. When another mounting method using solder balls, ACFs (anisotropic conductive films), ACPs (anisotropic conductive pastes) or the like are used, processing appropriate for respective mounting method is selected.

One or plurality of semiconductor devices selected from a group consisting of a resonant tunneling diode (RTD), a Schottky-barrier diode (SBD), a TUNNETT (Tunnel Transit Time) diode, an IMPATT (Impact Ionization Avalanche Transit Time) diode, a high electron mobility transistor (HEMT), a GaAs field effect transistor (FET), a GaN field effect transistor (FET) and a Heterojunction Bipolar Transistor (HBT) is used as the semiconductor device 30. These semiconductor devices are active elements. A quantum element, for example, can be used as the semiconductor device 30. In the present embodiment, the semiconductor device 30 is a Schottky-barrier diode.

FIG. 5 is a schematic diagram showing the mounting of the semiconductor device 30 using the flip chip mounting method. As shown in FIG. 5, the semiconductor device 30 has terminals 31a, 31b. The terminals 31a, 31b are an anode and a cathode of a diode, for example. The semiconductor device 30 is positioned above the electrodes 20a, 20b such that the terminals 31a, 31b are directed downward, and the terminals 31a, 31b are bonded to the electrodes 20a, 20b using Au stud bumps 32, respectively.

FIG. 6 is a schematic diagram showing the mounting of the semiconductor device 30 using the wire bonding mounting method. As shown in FIG. 6, the semiconductor device 30 is positioned on the electrodes 20a, 20b such that the terminals 31a, 31b are directed upward, and the terminals 31a, 31b are connected to the electrodes 20a, 20b respectively using Au bonding wires 33.

In the antenna body 6 of FIG. 3, an area from the opening end E1 of the taper slot S to the mount portion for the semiconductor device 30 functions as a transmitter/receiver that transmits or receives the electromagnetic wave. The frequency of the electromagnetic wave transmitted or received by the antenna body 6 is determined by the width of the taper slot S and an effective permittivity of the tapered slot S. The effective permittivity of the tapered slot S is calculated based on the relative permittivity of the air between the electrodes 20a, 20b, and the relative permittivity and the thickness of the dielectric film 10.

Generally, a wavelength λ of the electromagnetic wave in a medium is expressed in the following formula.

λ=λ₀/√∈_{ref}

λ₀ is a wavelength of the electromagnetic wave in a vacuum, and ∈_{ref} is an effective relative permittivity of the medium. Therefore, if the effective relative permittivity of the tapered slot S increases, a wavelength of the electromagnetic wave in the tapered slot S is shortened. In contrast, if the effective relative permittivity of the tapered slot S decreases, a wavelength of the electromagnetic wave in the tapered slot S is lengthened. When the effective relative permittivity of the tapered slot S is assumed to be minimum 1, the electromagnetic wave of 0.1 THz is transmitted or received at a portion where the width of the tapered slot S is 1.5 mm. The tapered slot S preferably includes a portion having the width of 2 mm in consideration of a margin.

The length of the tapered slot S is preferably not less than 0.5 mm and not more than 30 mm. A mount area for the semiconductor device 30 can be ensured when the length of the tapered slot S is not less than 0.5 mm. Further, the length of the tapered slot S is preferably not more than 30 mm on the basis of 10 wavelengths.

### (1-2) Operation of Antenna Body

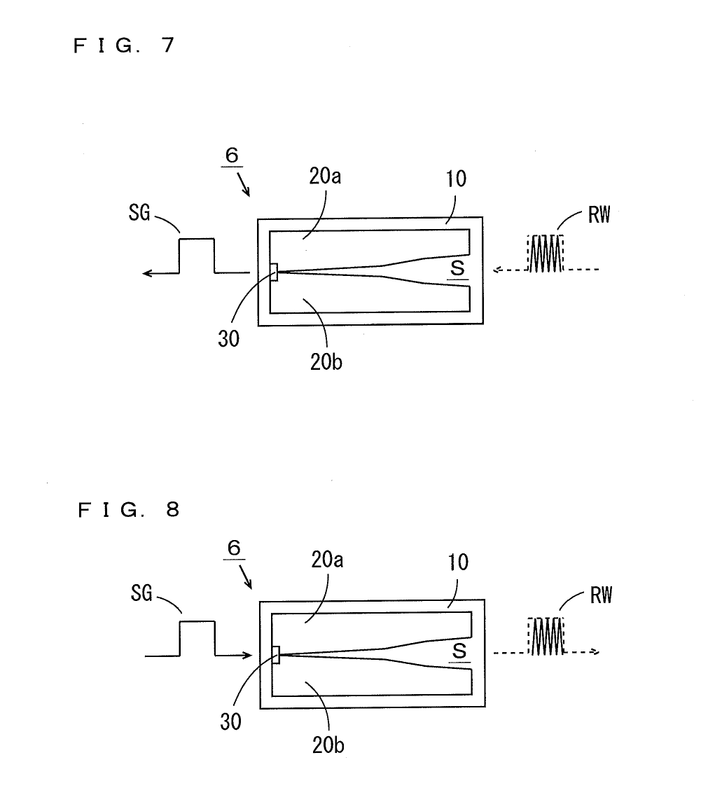

FIG. 7 is a schematic plan view showing the reception operation of the antenna body 6 according to the present embodiment. In FIG. 7, an electromagnetic wave RW includes a digital intensity modulated signal wave having a frequency (0.3 THz, for example) in the terahertz band and a signal wave having a frequency (1 GHz, for example) in a gigahertz band. The electromagnetic wave RW is received in the tapered slot S of the antenna body 6. Thus, an electric current having a frequency component in the terahertz band flows in the electrodes 20a, 20b. The semiconductor device 30 performs detection and rectification. Thus, a signal SG having a frequency (1 GHz, for example) in the gigahertz band is output from the semiconductor device 30.

FIG. 8 is a schematic plan view showing the transmission operation of the antenna body 6 according to the present embodiment. In FIG. 8, the signal SG having a frequency (1 GHz, for example) in the gigahertz band is input to the semiconductor device 30. The semiconductor device 30 performs oscillation. Thus, the electromagnetic wave RW is transmitted from the tapered slot S of the antenna body 6. The electromagnetic wave RW includes the digital intensity modulated signal wave having a frequency (0.3 THz, for example) in the terahertz band and a signal wave having a frequency (1 GHz, for example) in the gigahertz band.

### (1-3) Directivity of Antenna Body

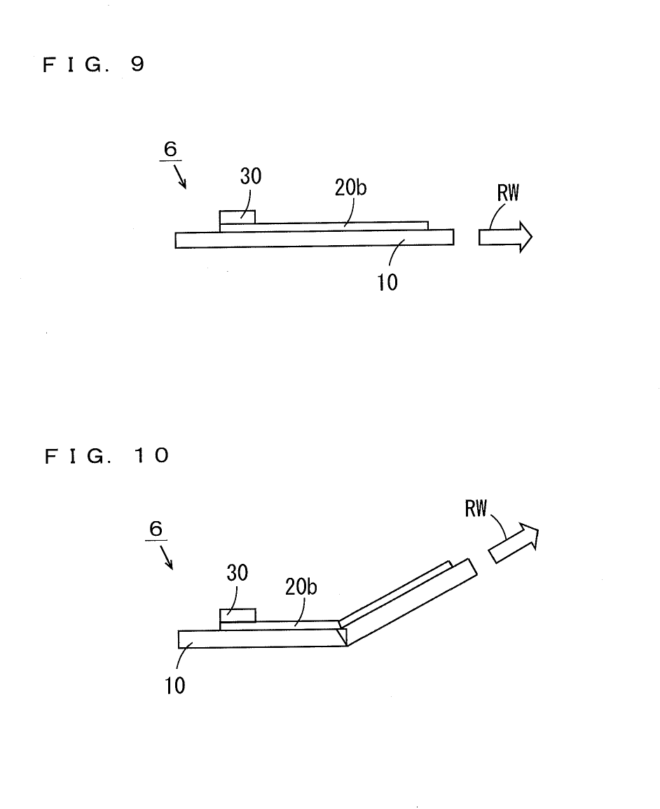

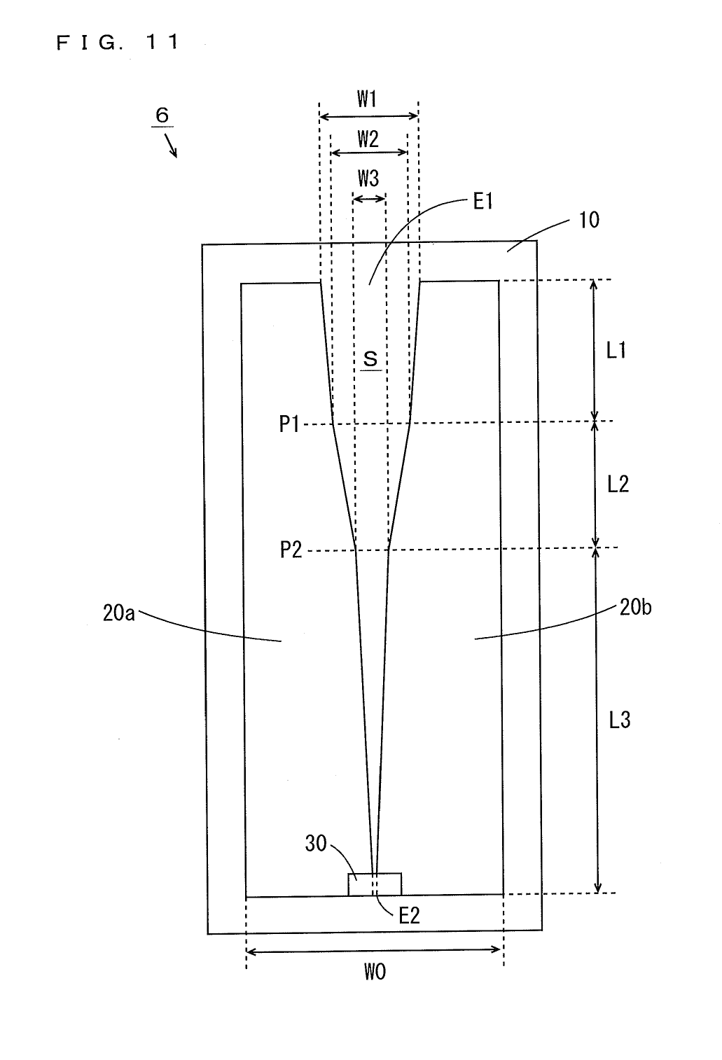

FIG. 9 is a schematic side view for explaining the directivity of the antenna body 6 according to the present embodiment.

In FIG. 9, the antenna body 6 radiates a carrier wave modulated by the signal wave as the electromagnetic wave RW. In this case, because the relative permittivity of the dielectric film 10 is low, the electromagnetic wave RW is not attracted to the dielectric film 10. Therefore, the electromagnetic wave RW advances in the central axis direction of the antenna body 6.

FIG. 10 is a schematic side view for explaining the change in directivity of the antenna body 6 according to the present embodiment.

The dielectric film 10 of the antenna body 6 is flexible. Therefore, the antenna body 6 can be bent along an axis that intersects with the central axis direction. Thus, as shown in FIG. 10, the radiation direction of the electromagnetic wave RW can be changed to any direction.

As shown in FIG. 1, in the present embodiment, the back surface of the dielectric film 10 is attached to the support surfaces 7a, 7b of the support body 5 with the antenna body 6 being bent along an axis vertical to the central axis direction. Thus, the radiation direction of the electromagnetic wave RW can be fixed to a desired direction. Further, material having a lower relative permittivity is used as the material for the support body 5, whereby the radiation direction of the electromagnetic wave RW can be more accurately adjusted.

### (1-4) Characterization of Antenna Body

Characteristics of the antenna body 6 according to the present embodiment were evaluated by the simulation and an experiment.

(a) Dimensions of Antenna Body 6

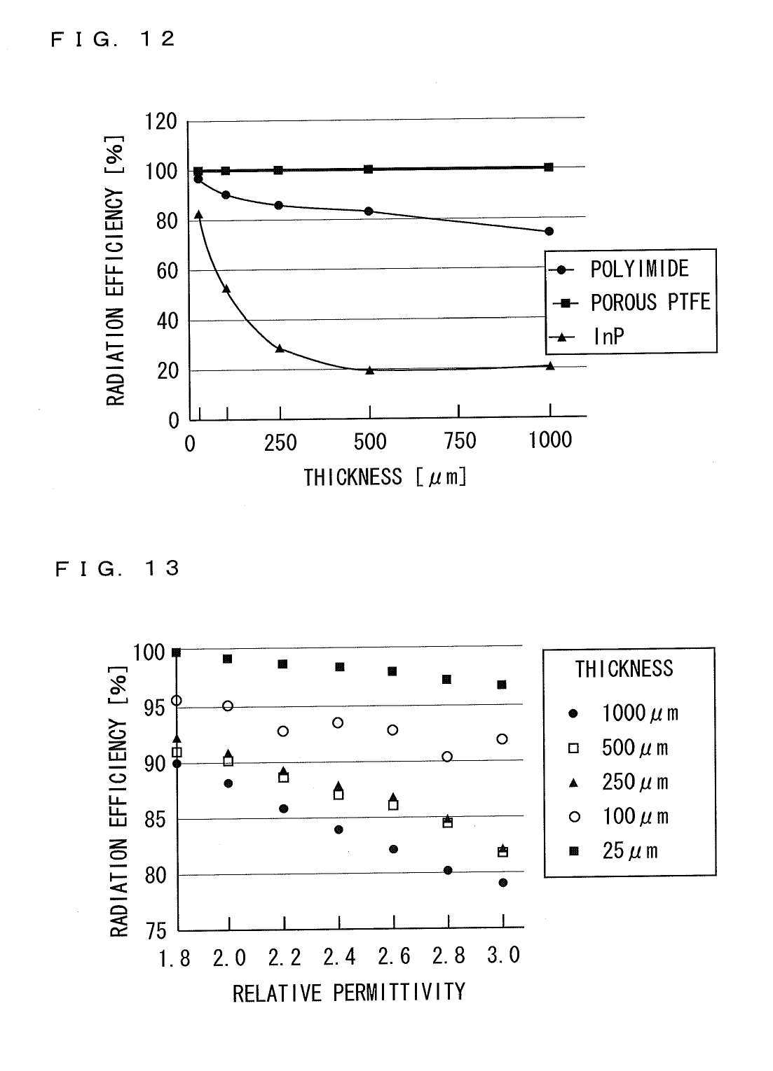

FIG. 11 is a schematic plan view for explaining the dimensions of the antenna body 6 used for the simulation and the experiment.

The distance WO between the outer end edges of the electrodes 20a, 20b in the width direction is 2.83 mm. The width W1 of the tapered slot S at the opening end E1 is 1.11 mm. The widths W2, W3 of the tapered slot S at positions P1, P2 between the opening end E1 and the mount end E2 are 0.88 mm and 0.36 mm, respectively. The length L1 between the opening end E1 and the position P1 is 1.49 mm, and the length L2 between the position P1 and the position P2 is 1.49 mm. The length L3 between the position P2 and the mount end E2 is 3.73 mm. The width of the tapered slot S at the mount end E2 is 50 μm.

(b) Simulation of Radiation Efficiency

The radiation efficiency at 300 GHz were found by the electric field simulation using polyimide, porous PTFE and InP that is a semiconductor material as the material for the dielectric film 10, provided that the thickness of the dielectric film 10 is 25 μm, 100 μm, 250 μm, 500 μm and 1000 μm. The value of the relative permittivity of polyimide was considered as 3.2, the value of the relative permittivity of porous PTFE was considered as 1.6, and the value of the relative permittivity of InP was considered as 12.4.

Radiation efficiency is expressed in the following formula.

Radiation efficiency=Radiation Power/Supply Power

The supply power is the electric power supplied to the antenna body 6. The radiation power is the electric power radiated from the antenna body 6. In the present simulation, the supply power is 1 mW.

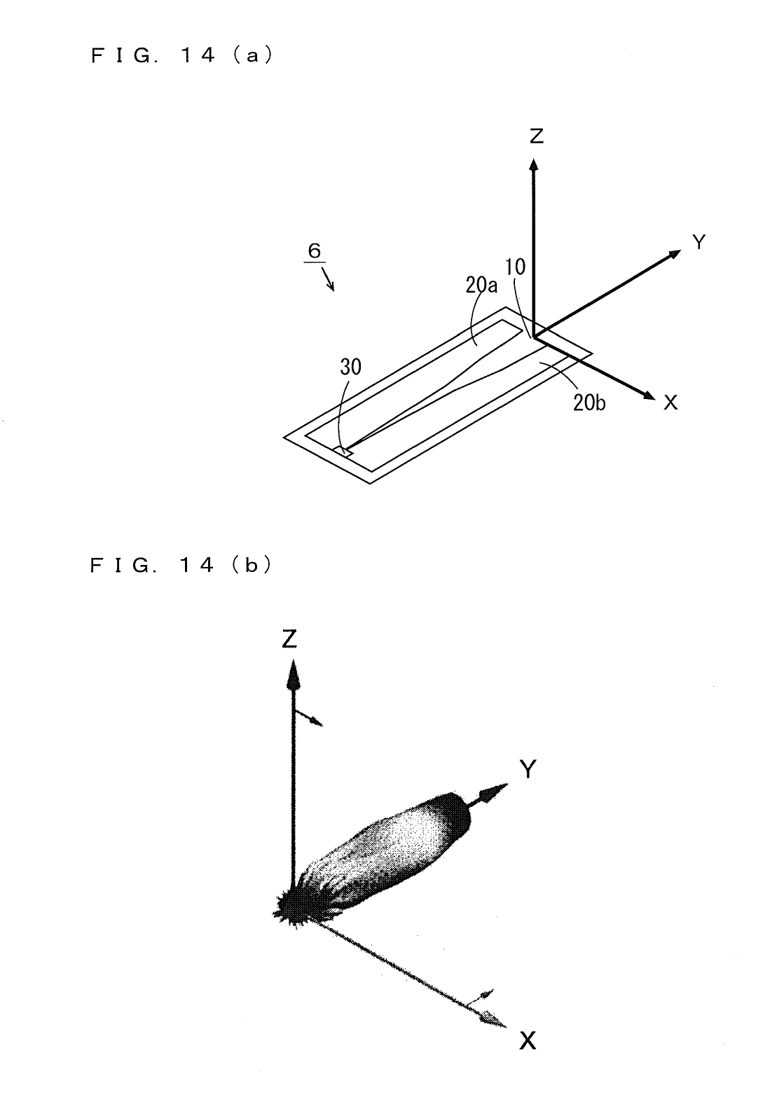

FIG. 12 is a diagram showing the simulation results of the relation between the thickness of the dielectric film 10 and the radiation efficiency at 300 GHz. The ordinate of FIG. 12 indicates the radiation efficiency, and the abscissa indicates the thickness of the dielectric film 10.

As shown in FIG. 12, when porous PTFE is used as the material for the dielectric film 10, the radiation efficiency of substantially 100% is obtained with the thickness of the dielectric film 10 being in a range from 25 μm to 1000 μm. When polyimide is used as the material for the dielectric film 10, the radiation efficiency of substantially not less than 75% is obtained with the thickness of the dielectric film 10 being in a range from 25 μm to 1000 μm. When InP is used as the material for the dielectric film 10, the radiation efficiency sharply decreases as the thickness of the dielectric film 10 increases from 25 μm to 250 μm. When the thickness of the dielectric film 10 is more than 500 μm, the radiation efficiency decreases to approximately 20%.

Therefore, it is found that when resin is used as the material for the dielectric film 10, the radiation efficiency is high in a wide range of the thickness of the dielectric film 10, as compared to a case in which a semiconductor material is used as the material for the dielectric film 10. It is found that when porous resin is used in particular, the radiation efficiency is high regardless of the thickness of the dielectric film 10.

Meanwhile, at the time of mounting the semiconductor device 30 on a semiconductor substrate such as InP, the thickness of the semiconductor substrate is preferably at least 200 μm. If the thickness of the semiconductor substrate is less than 200 μm, it is difficult to handle the semiconductor device 30, and the semiconductor substrate is easy to be damaged. From the above results, if the thickness of the semiconductor substrate is not less than 200 μm, the radiation efficiency decreases to not more than about 30%.

Next, the radiation efficiency at 300 GHz was found by the electromagnetic field simulation, provided that the relative permittivity of the dielectric film 10 is 1.8, 2.0, 2.2, 2.4, 2.6, 2.8 and 3.0.

FIG. 13 is a diagram showing the simulation results of the relation between the relative permittivity of the dielectric film 10 and the radiation efficiency at 300 GHz.

As shown in FIG. 13, the lower the relative permittivity of the dielectric film 10 is, the higher the radiation efficiency is. Further, the smaller the thickness of the dielectric film 10 is, the higher the radiation efficiency is.

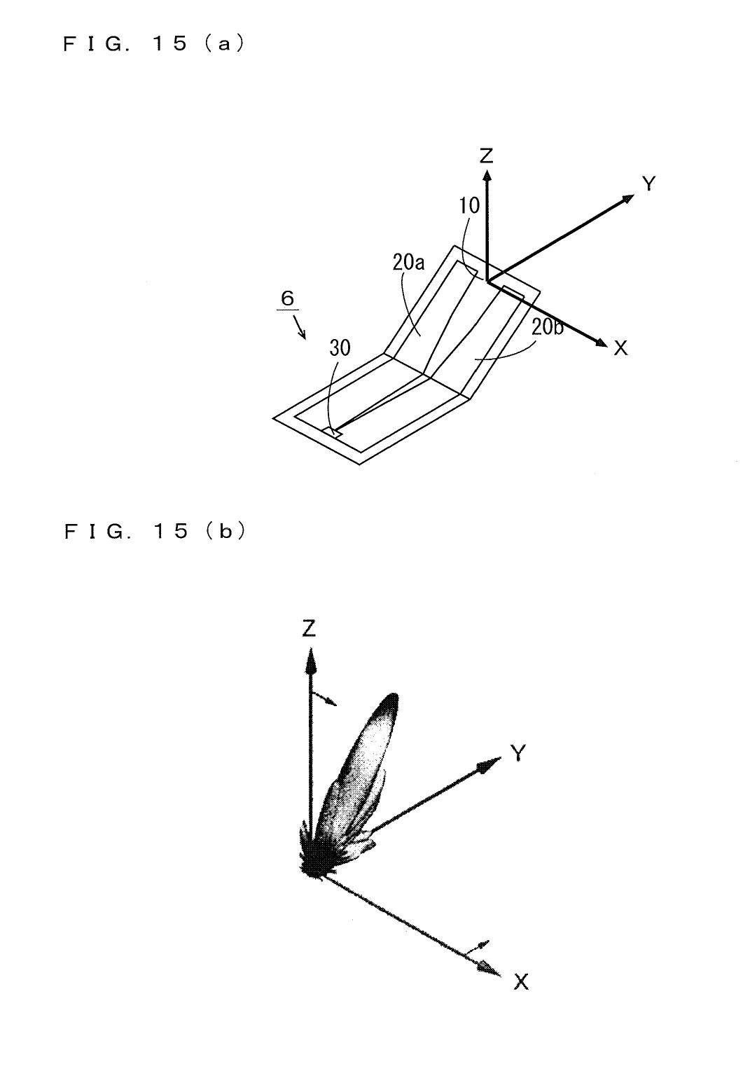

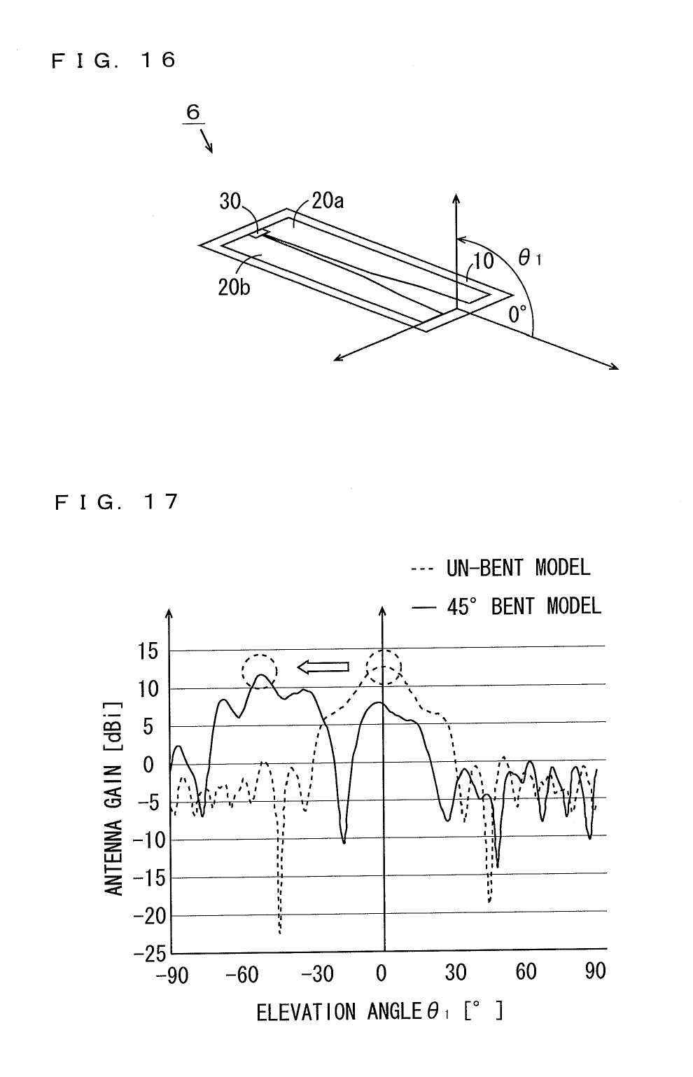

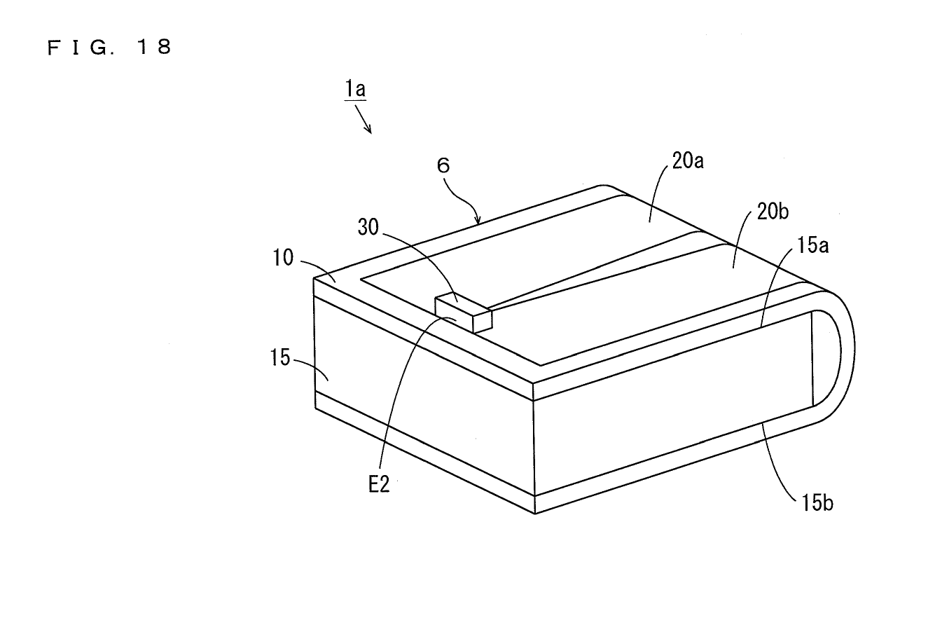

Further, the change in directivity that occurs when the antenna module 1 is not bent and when the antenna module is bent was found by the electromagnetic field simulation. FIGS. 14(a) and 14(b) are diagrams showing the results of the three-dimensional electromagnetic field simulation obtained when the antenna module 1 is not bent. FIGS. 15(a) and 15(b) are diagrams showing the results of the three-dimensional electromagnetic field simulation obtained when the antenna module 1 is bent. FIGS. 14(a) and 15(a) are diagrams for explaining the definition of the directions of the antenna module 1, and FIGS. 14(b) and 15(b) are diagrams showing the radiation characteristics (directivity) of the antenna module 1.

The central axis direction of the antenna module 1 is referred to as the Y direction, a direction parallel to the main surface of the dielectric film 10 and orthogonal to the Y direction is referred to as the X direction, and a direction vertical to the main surface of the dielectric film 10 is referred to as the Z direction.

When the antenna module 1 is not bent as shown in FIG. 14(a), the electromagnetic wave is radiated in the Y direction as shown in FIG. 14(b).

When the antenna module 1 is bent obliquely upward by 45° along an axis parallel to the X direction as shown in FIG. 15(a), the electromagnetic wave is radiated obliquely upward by 45° with respect to the Y direction in the YZ plane as shown in FIG. 15(b).

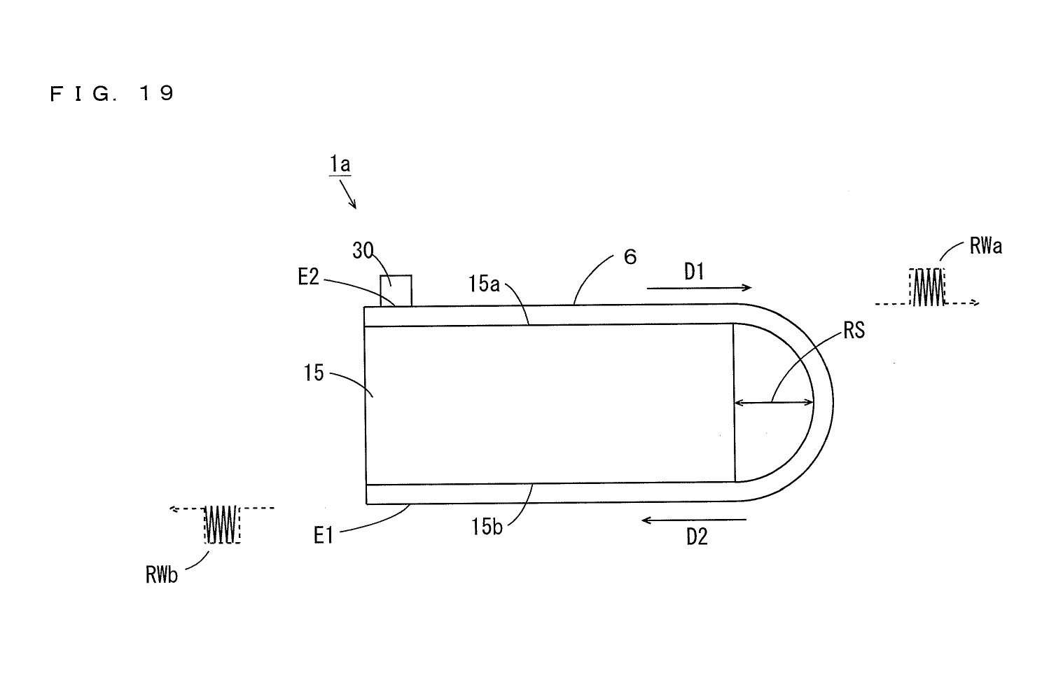

Further, the antenna gain obtained when the antenna module 1 is not bent and when the antenna module 1 is bent was found by the simulation. FIG. 16 is a schematic diagram for explaining the definition of the reception angle of the antenna module 1 in the simulation. In FIG. 16, the central axis direction of the antenna module 1 is considered as 0°. Further, a plane parallel to the main surface of the dielectric film 10 is referred to as a parallel plane, and a plane vertical to the main surface of the dielectric film 10 is referred to as a vertical plane. Further, an angle that is formed in the vertical plane with respect to the central axis direction is referred to as an elevation angle θ₁.

FIG. 17 is a diagram showing the calculation results of the antenna gain obtained when the antenna module 1 is not bent and when the antenna module 1 is bent. The ordinate of FIG. 17 indicates the antenna gain [dBi], and the abscissa indicates the elevation angle θ₁. The calculation results of the antenna gain of the antenna module 1 that is not bent (un-bent model) is indicated by the dotted line, and the calculation results of the antenna gain of the antenna module 1 that is bent (45° bent model) is indicated by the solid line.

As shown in FIG. 17, when the antenna module 1 is not bent, the position of the peak of the antenna gain is at 0°, and when the antenna module 1 is bent, the position of the peak of the antenna gain is shifted to about 45°.

From these results, it is found that the direction of the directivity of the antenna module 1 can be arbitrarily set by bending the antenna module 1.

### (1-5) Effects of First Embodiment

In the antenna module 1 according to the present embodiment, the dielectric film 10 is formed of resin to be bendable. Thus, the orientations of the electrodes 20a, 20b can be easily changed, and the receipt direction or the transmission direction of the electromagnetic wave can be easily adjusted. Further, because the bent dielectric film 10 is supported by the support body 5, the shape-retaining property of the dielectric film 10 is ensured. Thus, the radiation direction of the electromagnetic wave can be fixed to an adjusted direction. Therefore, even if the degree of freedom in arranging the antenna module 1 is limited, the receipt direction or the transmission direction of the electromagnetic wave can be set to a desired direction.

Further, because the dielectric film 10 is formed of resin, the effective permittivity of the tapered slot S is reduced. Thus, the electromagnetic wave radiated from the electrodes 20a, 20b and the electromagnetic wave received by the electrodes 20a, 20b are less likely attracted to the dielectric film 10. Therefore, the electromagnetic wave can be efficiently radiated, and the better directivity of the antenna module is obtained.

Further, because the effective permittivity of the tapered slot S is low, the transmission loss of the electromagnetic wave is reduced. Thus, the transmission speed and the transmission distance can be improved.

### (2) Second Embodiment

FIG. 18 is an external perspective view of the antenna module according to the second embodiment of the present invention. FIG. 19 is a schematic side view of the antenna module of FIG. 18. Regarding an antenna module 1a of FIGS. 18 and 19, difference from the antenna module 1 of FIGS. 1 and 2 will be described.

The antenna module 1a of FIGS. 18 and 19 includes a rectangular parallelepiped support body 15 instead of the support body 5 of FIGS. 1 and 2. The antenna body 6 is attached to one surface 15a of the support body 15 and the other surface 15b parallel to the one surface 15a while being bent in a U-shape. The one surface 15a of the support body 15 is an example of a third surface of claim 2, and the other surface 15b is an example of a fourth surface of claim 4. A portion of the dielectric film 10 attached to the one surface 15a of the support body 15 is an example of a first portion of claim 2, and a portion of the dielectric film 10 attached to the other surface 15b is an example of a second portion of claim 4. In this case, the mount end E2 (FIG. 3) of the antenna body 6 is positioned on the one surface 15a of the support body 15, and the opening end E1 (FIG. 3) is positioned on the other surface 15b of the support body 15. The mount end E2 and the opening end E1 are positioned to face each other with the support body 15 held therebetween.

As shown in FIG. 19, the central axis direction D1 on the one surface 15a side of the support body 15 and the central axis direction D2 on the other surface 15b side of the support body 15 are different by 180°. In this case, an electromagnetic wave RWa is radiated in the central axis direction D1, and an electromagnetic wave RWb is radiated in the central axis direction D2 opposite to the central axis direction D1.

The directivity of the antenna module 1a is different depending on the material for the support body 15 and the radius of curvature (hereinafter referred to as radius of curvature RS) at the curved portion of the antenna body 6. The relation between the material for the support body 15 and the directivity in the antenna module 1a, and the relation between the radius of curvature RS and the directivity were found by the electromagnetic field simulation.

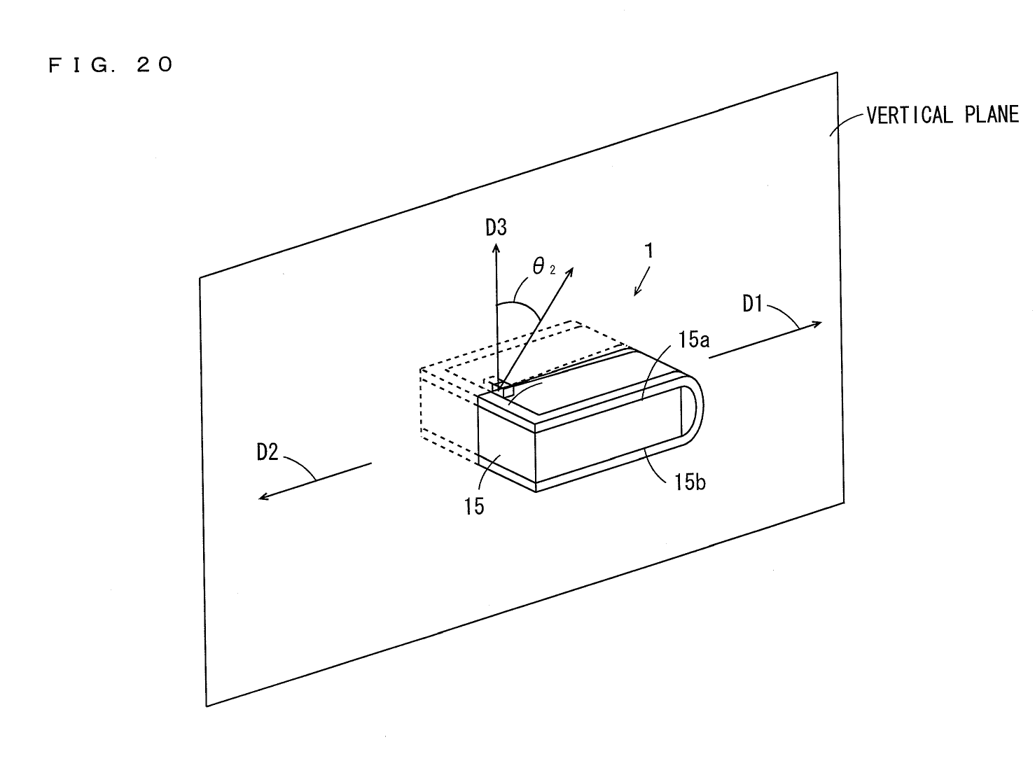

FIG. 20 is a schematic diagram for explaining the definition of the transmission/receipt angle of the antenna module 1a in the simulation. In FIG. 20, a plane that is vertical to the one surface 15a and the other surface 15b of the support body 15, and passes in the central axis directions D1, D2 of the antenna body 6 is referred to as a vertical plane. Further, in the vertical plane, a direction that is vertical to the central axis directions D1, D2 and is directed from the other surface 15b to the one surface 15a of the support body 15 is referred to as a reference direction D3. Further, an angle formed with the reference direction D3 in the vertical plane is referred to as an elevation angle θ₂. The elevation angle θ₂ in the central axis direction D1 is 90 degrees, and the elevation angle θ₂ in the central axis direction D2 is 270 degrees. The change in antenna gain [dBi] due to the change in elevation angle θ₂ was calculated in the simulation.

The antenna body 6 has the dimensions explained in FIG. 11. Further, the thickness of the copper layer 201 of FIG. 4 in the electrodes 20a, 20b is 15 μm, the thickness of the nickel layer 202 is 3 μm and the thickness of the gold layer 203 is 0.2 μm. Further, the thickness of the dielectric film 10 is 25 μm.

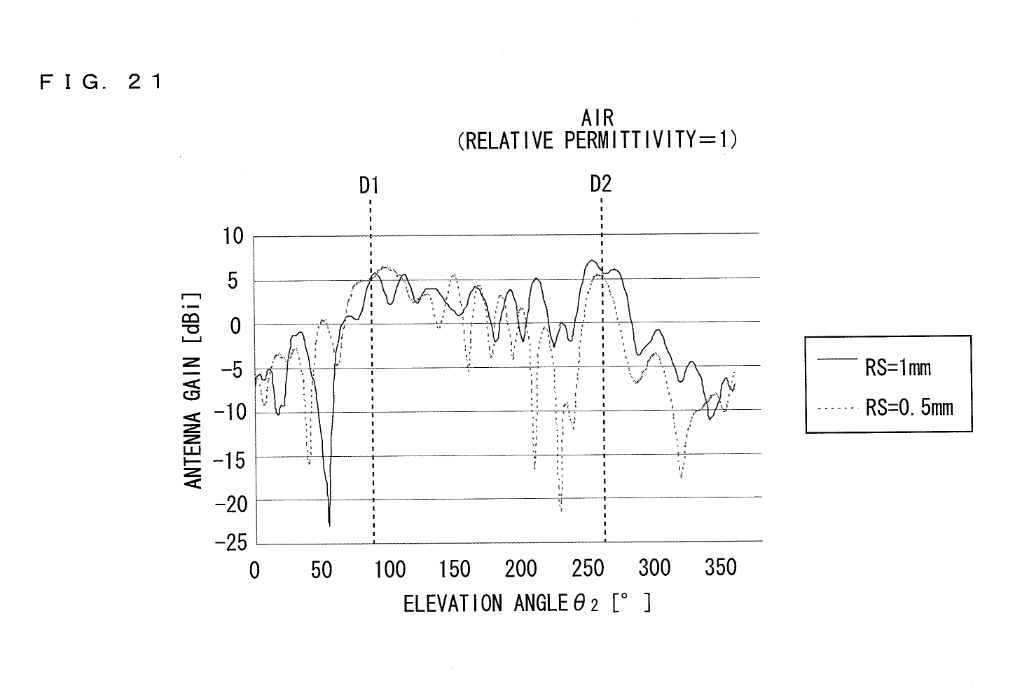

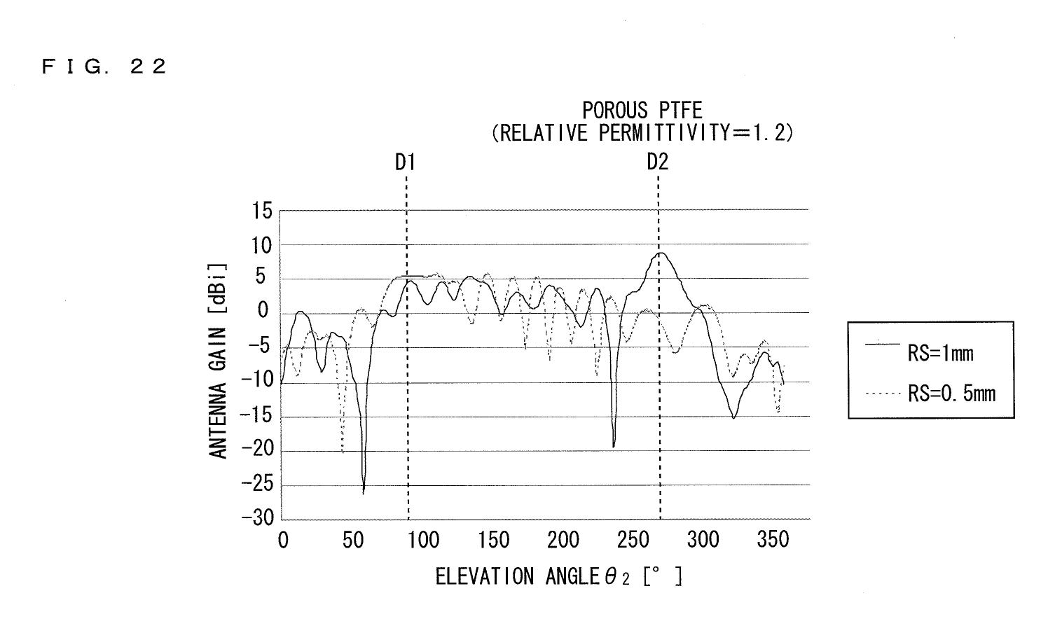

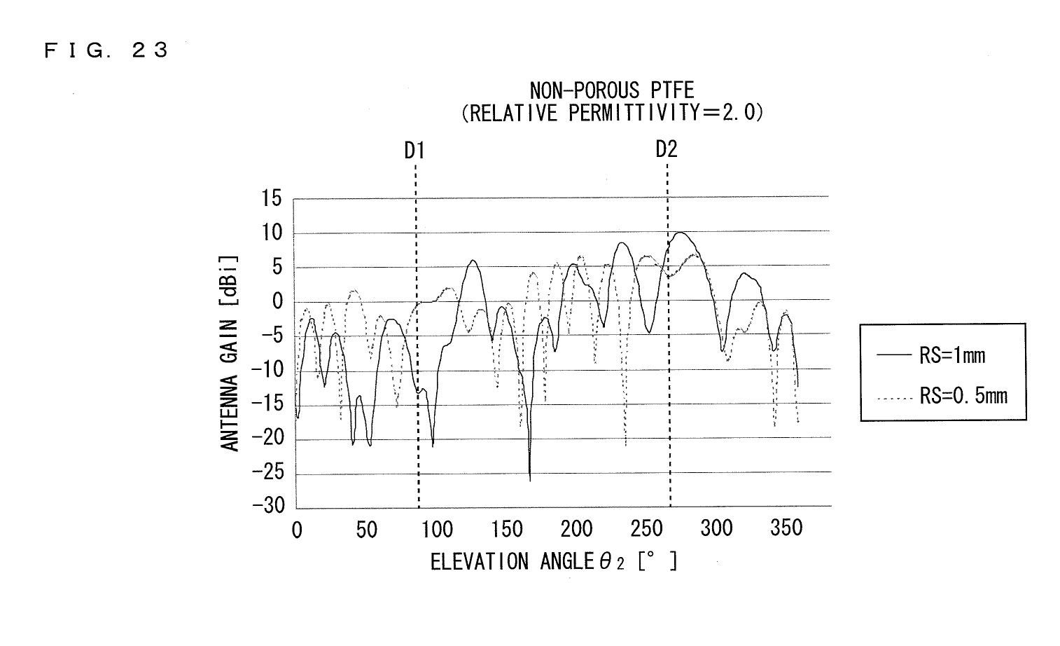

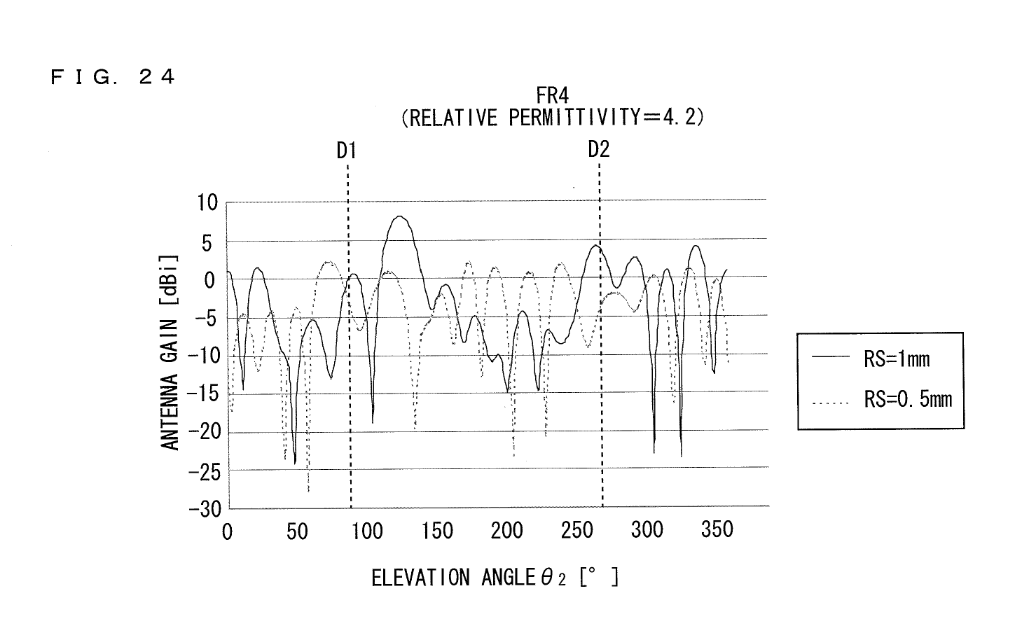

FIG. 21 shows the calculation results of the antenna gain [dBi] obtained when air is arranged instead of the support body 15, that is, the support body 15 is not arranged but the antenna body 6 is simply bent in a U-shape. FIG. 22 shows the calculation results of the antenna gain [dBi] obtained when porous PTFE is used as the material for the support body 15. FIG. 23 shows the calculation results of the antenna gain [dBi] obtained when PTFE that is not porous (hereinafter referred to as non-porous PTFE) is used as the material for the support body 15. FIG. 24 shows the calculation results of the antenna gain [dBi] obtained when FR4 is used as the material for the support body 15. The relative permittivity of air is 1, the relative permittivity of porous PTFE is 1.2, the relative permittivity of non-porous PTFE is 2.0 and the relative permittivity of FR4 is 4.2.

In FIGS. 21 to 24, the ordinates indicate the antenna gain [dBi], and the abscissas indicate the elevation angle θ₂. Further, the calculation results of the antenna gain obtained when the radius of curvature RS is 0.5 mm is indicated by the dotted line, and the calculation results of the antenna gain obtained when the radius of curvature RS is 1 mm is indicated by the solid line.

As shown in FIGS. 21 to 24, when the radius of curvature RS is 1 mm, the antenna gain in the central axis direction D2 is higher than the antenna gain in the central axis direction D1. In this case, the higher the relative permittivity of the material for the support body 15 is, the higher the antenna gain in the central axis direction D2 is.

In a case in which the radius of curvature RS is 0.5 mm, the relation between the magnitude of the antenna gain in the central axis direction D1 and the magnitude of the antenna gain in the central axis direction D2 is different depending on the material for the support body 15. For example, In a case in which the support body 15 is made of porous PTFE (FIG. 22), the antenna gain in the central axis direction D1 is higher than the antenna gain in the central axis direction D2. On the other hand, in a case in which the support body 15 is made of non-porous PTFE (FIG. 23), the antenna gain in the central axis direction D2 is higher than the antenna gain in the central axis direction D1. Further, in a case in which the support body 15 is formed of FR4 (FIG. 24), the antenna gain in the central axis direction D1 and the antenna gain in the central axis direction D2 are substantially the same.

Further, when the radius of curvature RS is 1 mm, the antenna gain in the central axis direction D1 is low as compared to a case in which the radius of curvature RS is 0.5 mm, and the antenna gain in the central axis direction D2 is increased.

From these results, it was found that the antenna gain in the central axis direction D1 and the antenna gain in the central axis direction D2 can be arbitrarily adjusted by the selection of the radius of curvature RS and the material for the support body 15.

### (3) Third Embodiment

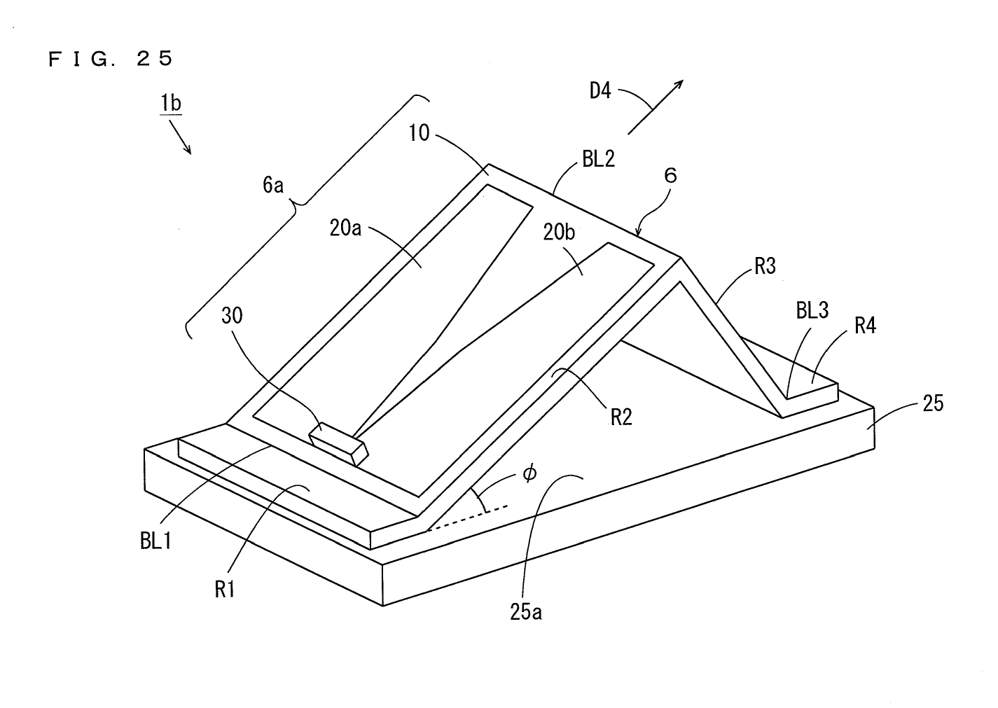

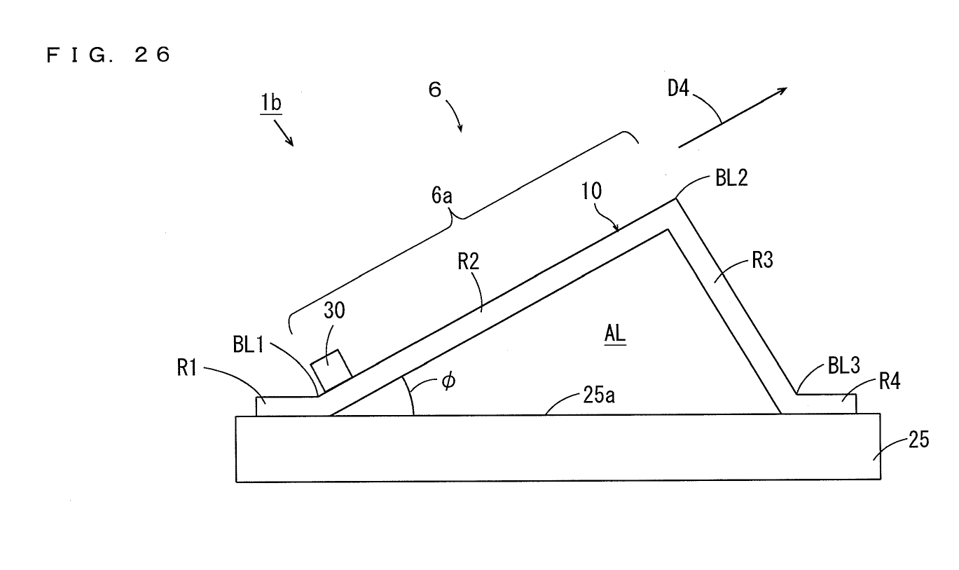

FIG. 25 is an external perspective view of the antenna module according to the third embodiment of the present invention. FIG. 26 is a schematic side view of the antenna module of FIG. 25. Regarding the antenna module 1b of FIGS. 25 and 26, difference from the antenna module 1 of FIGS. 1 and 2 will be described.

The antenna module 1b of FIGS. 25 and 26 includes a plate-shaped support body 25 instead of the support body 5 of FIGS. 1 and 2. The dielectric film 10 of the antenna body 6 includes portions R1, R2, R3, R4 that are arranged from the one end to the other end. The portion R1 is an example of a first portion of claim 2, the portion R2 is an example of a second portion of claim 2, the portion R3 is an example of a third portion of claim 7 and the portion R4 is an example of a fourth portion of claim 7. The pair of electrodes 20a, 20b and the semiconductor device 30 are provided on the main surface of the portion R2 of the dielectric film 10. An antenna portion 6a is constituted by the portion R2 of the dielectric film 10, the pair of electrodes 20a, 20b and the semiconductor device 30. The configuration of the antenna portion 6a is same as the configuration of the antenna body 6 of FIG. 3.

The dielectric film 10 is bent to form the valley fold at a boundary line BL1 between the portion R1 and the portion R2, is bent to form the mountain fold at a boundary line BL2 between the portion R2 and the portion R3 and is bent to form the valley fold at a boundary line BL3 between the portion R3 and the portion R4. The back surfaces of the portions R1, R4 are attached to one surface 25a of the support body 25. Thus, the portion R2 extends obliquely upward from the boundary line BL1, and the portion R3 extends obliquely downward from the boundary line BL2.

In the present example, an air layer AL is formed between the portion R2 of the dielectric film 10 and the one surface 25a of the support body 25. The air layer AL is an example of a space of claim 6. Because the relative permittivity of air is low as compared to the material used for the support body 25, the radiation efficiency of the electromagnetic wave having a used frequency can be sufficiently increased, and the transmission loss of the electromagnetic wave can be sufficiently reduced.

Further, a central axis direction D4 is parallel to the portion R2 of the dielectric film 10. Therefore, it is possible to easily adjust the radiation direction of the electromagnetic wave by adjusting an angle (hereinafter referred to as the bending angle φ) of the portion R2 of the dielectric film 10 with the one surface 25a of the support body 25.

Further, the larger the bending angle φ is, the shorter the distance between the portion R1 and the portion R4 of the dielectric film 10 is. Therefore, it is possible to reduce the dimensions of the support body 25 by increasing the angle φ. Thus, the antenna module 1 can be arranged in a small space.

The larger the bending angle φ is, the smaller the effect of the support body 25 on the transmission of the electromagnetic wave is, whereby the better transmission characteristics of the electromagnetic wave are obtained.

The relation between the bending angle φ and the transmission characteristics of the electromagnetic wave in the antenna module 1b was found by the simulation.

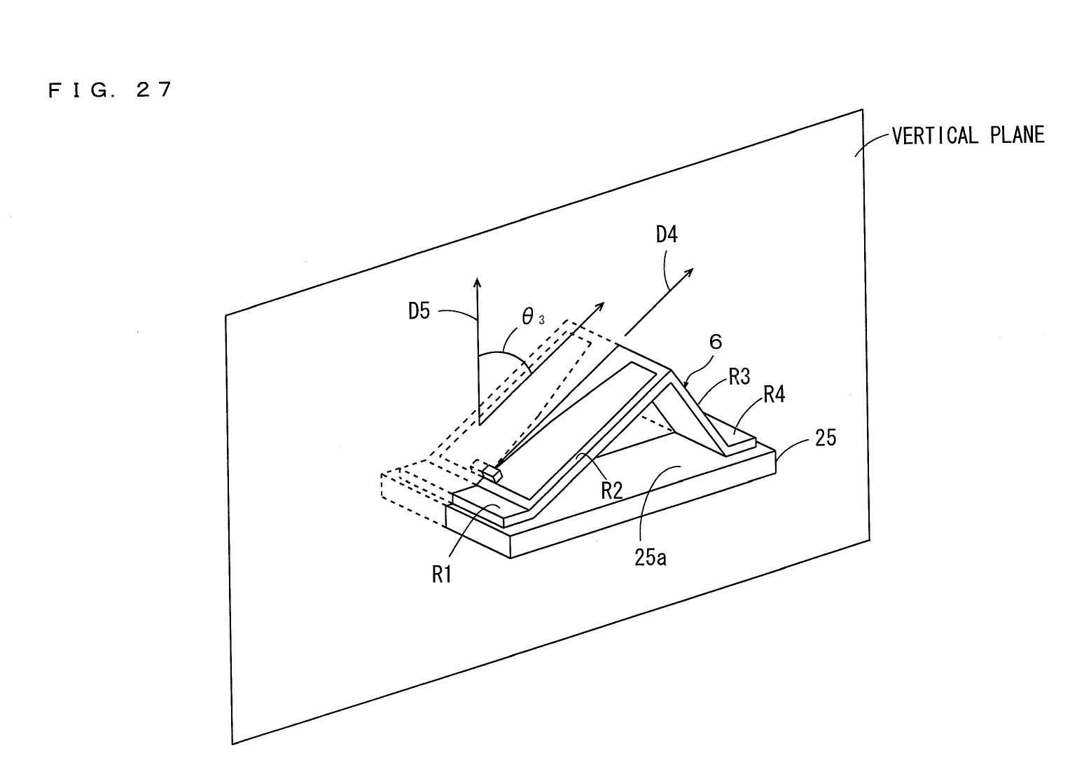

FIG. 27 is a schematic diagram for explaining the definition of the transmission/receipt angle of the antenna module 1b in the simulation. In FIG. 27, a plane that is vertical to the one surface 25a of the support body 25 and passes through the center of the mount end E2 (FIG. 3) and the opening end E1 (FIG. 3) of the antenna body 6 is referred to as a vertical plane. Further, in the vertical plane, a direction vertical to the one surface 25a of the support body 15 is referred to as a reference direction D5. Further, in the vertical plane, an angle formed with the reference direction D5 is referred to as an elevation angle θ₃.

In the simulation, the bending angle φ is set to 0°, 5°, 10°, 15°, 30° and 45°. The dimensions of the antenna portion 6a in the simulation is same as the dimensions of the antenna body 6 in the simulation of FIGS. 21 to 24. The dimensions of the support body 25, the dimensions of the portion R3 of the dielectric film 10, and the distance between the portion R1 and the portion R4 are appropriately set according to the bending angle φ.

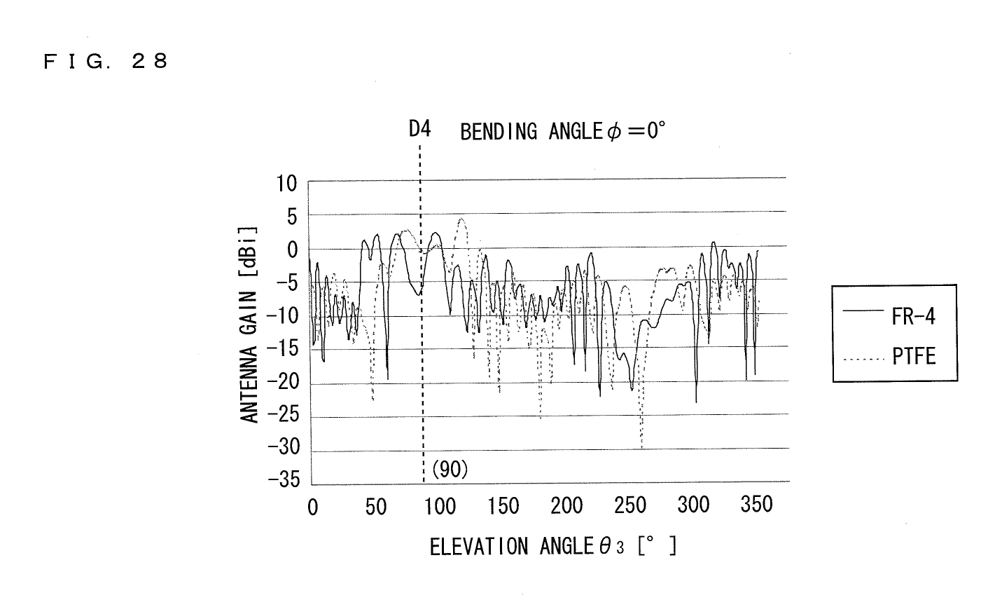

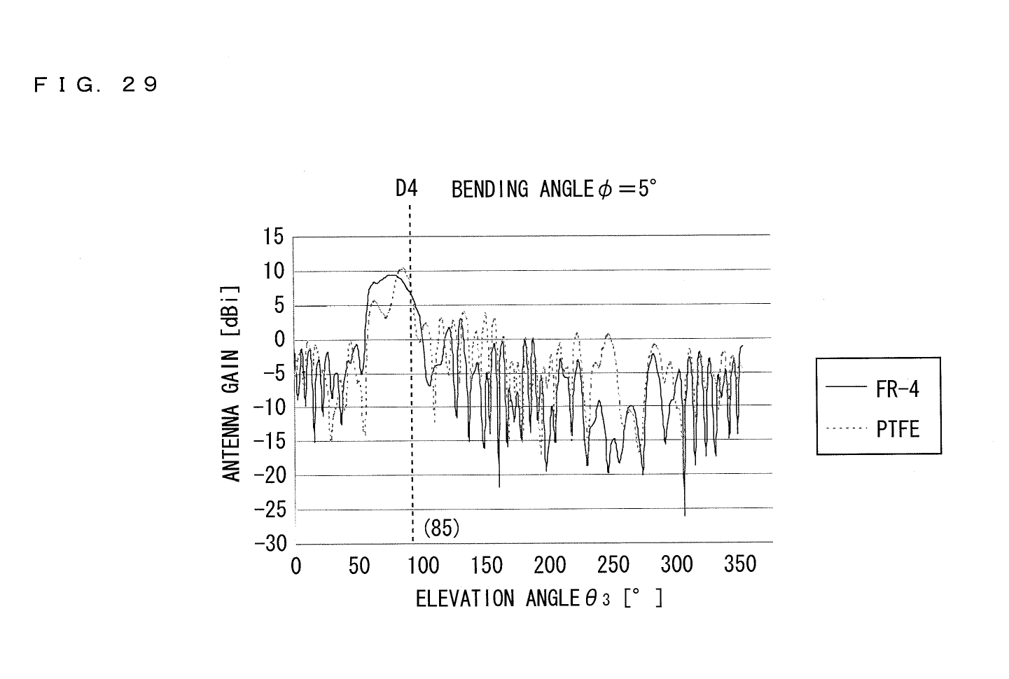

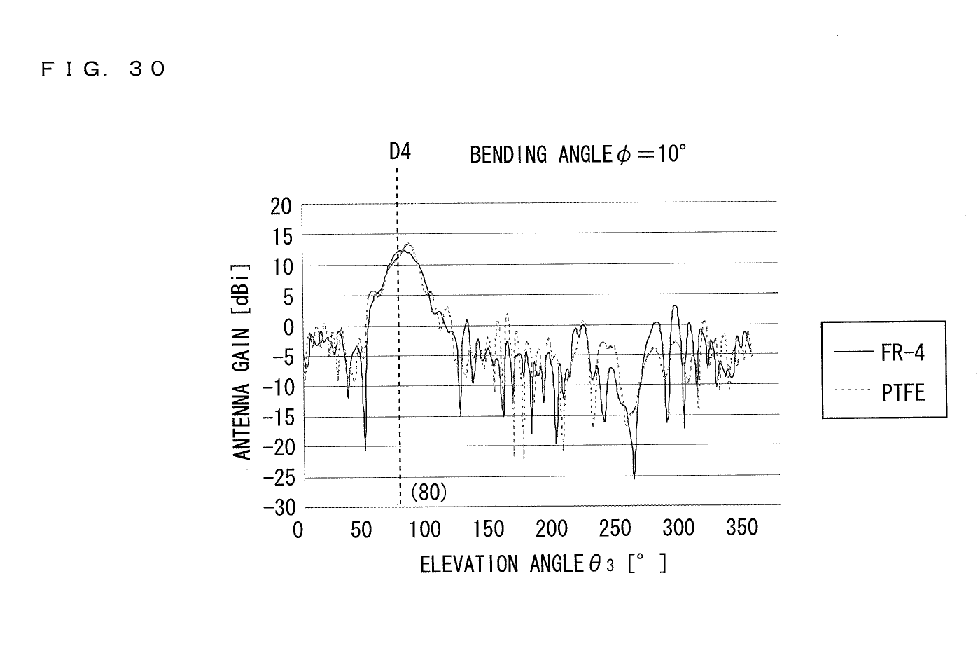

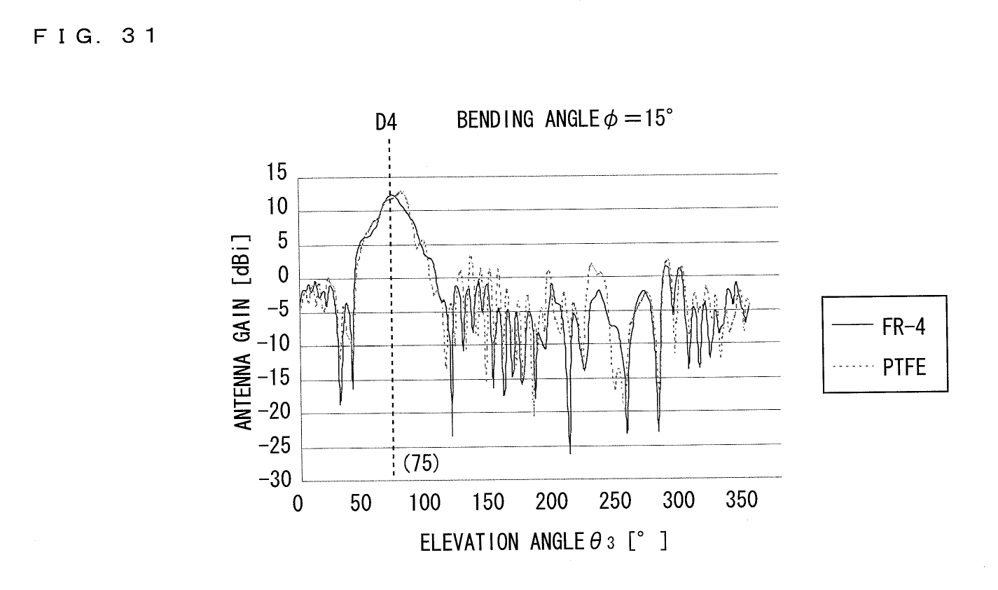

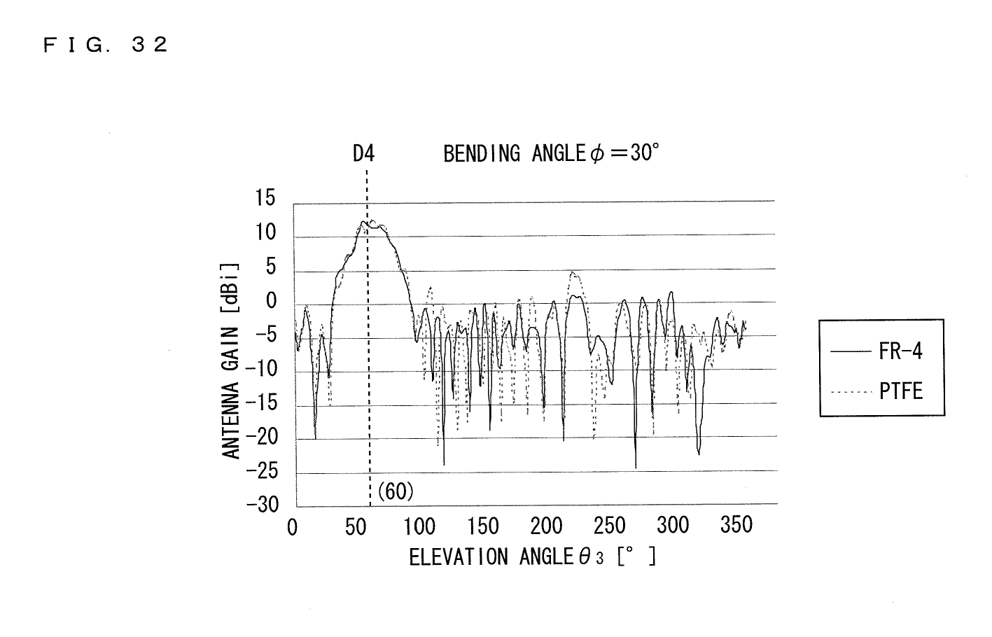

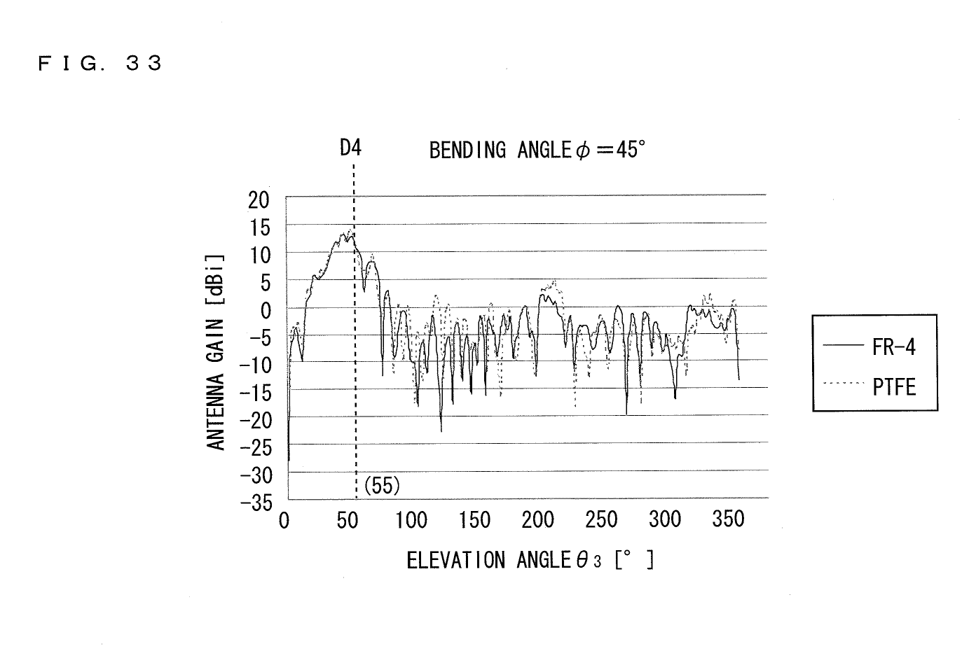

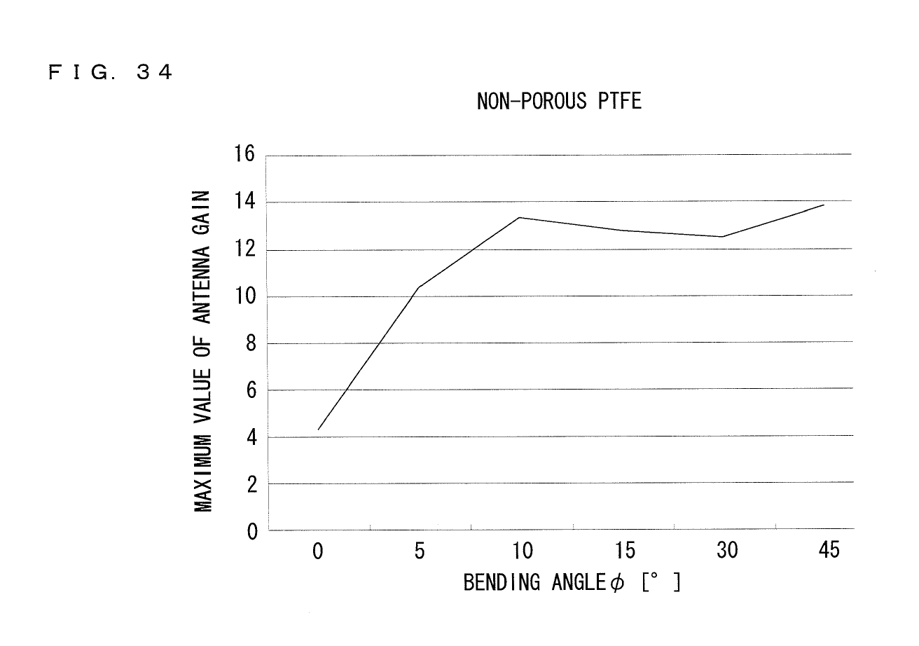

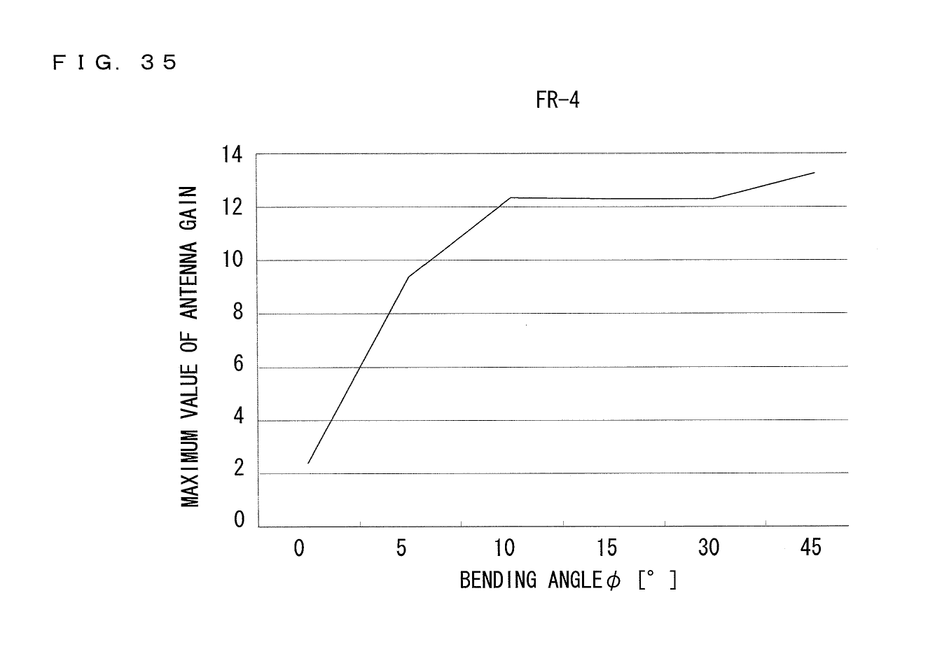

Regarding each of a case in which non-porous PTFE is used and a case in which FR4 is used, as the material for the support body 25, the change in antenna gain [dBi] due to the change in bending angle φ was calculated. FIGS. 28 to 33 respectively show the calculation results of the antenna gain [dBi] obtained when the bending angle φ is 0°, 5°, 10°, 15°, 30° and 45°. In FIGS. 28 to 33, the abscissas indicate the elevation angle θ₃, and the ordinates indicate the antenna gain. FIG. 34 shows the relation between the bending angle φ and the maximum value of the antenna gain obtained when non-porous PTFE is used as the material for the support body 25. FIG. 35 shows the relation between the bending angle φ and the maximum value of the antenna gain obtained when FR4 is used as the material for the support body 25. In FIGS. 34 and 35, the abscissas indicate the bending angle (I), and the ordinates indicate the maximum value of the antenna gain.

In FIGS. 28 to 33, the central axis direction D4 of the antenna portion 6a is indicated by the dotted line, and the elevation angle θ₃ in the central axis direction D4 is indicated in brackets. As shown in FIGS. 28 to 35, it was found that when the antenna portion 6a is bent, the maximum value of the antenna gain is high as compared to a case in which the antenna portion 6a is not bent (in a case in which the bending angle φ is 0°). This is considered to be because an air layer AL having a low relative permittivity is formed on the back surface side of the dielectric film 10 in a case in which the antenna 6a is bent. In particular, when the bending angle φ is not less than 5°, the antenna gain that is not less than 9 dBi is obtained, and when the bending angle φ is not less than 10°, the antenna gain that is not less than 12 dBi is obtained. Further, when non-porous PTFE is used as the material for the support body 25, the maximum value of the antenna gain is higher as compared to a case in which FR4 is used.

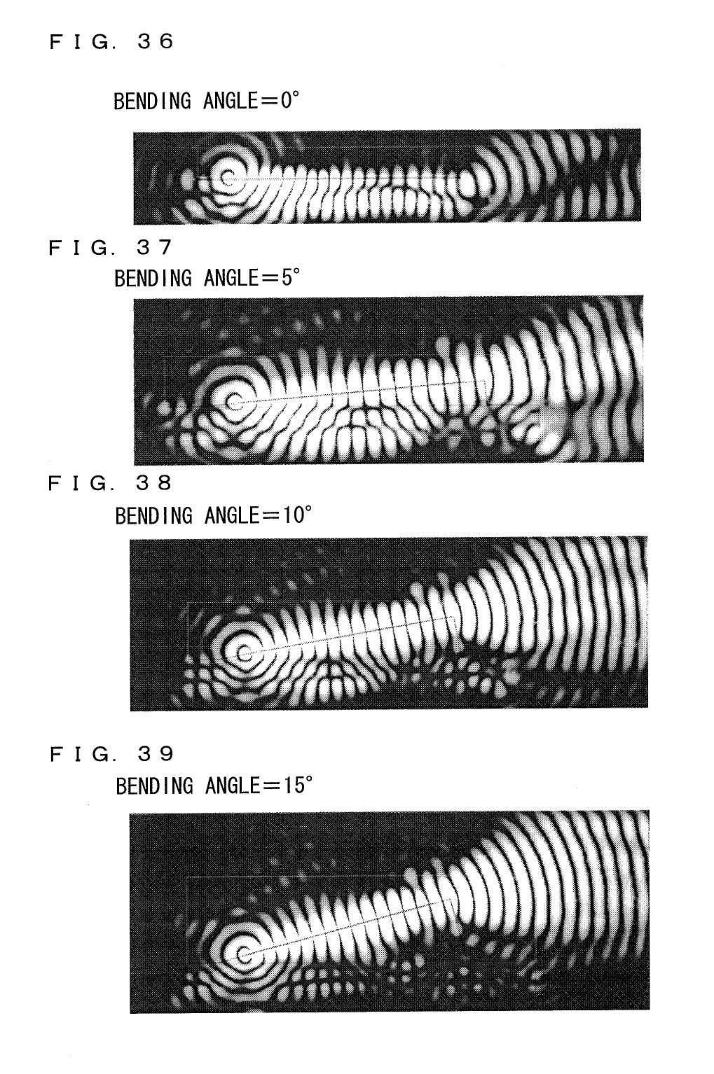

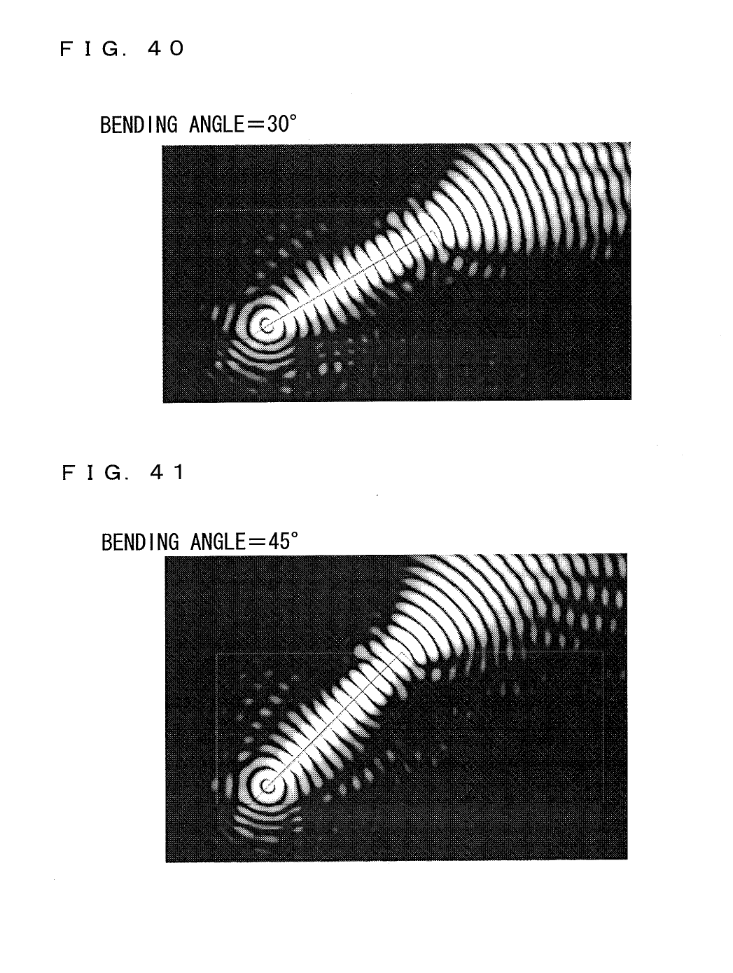

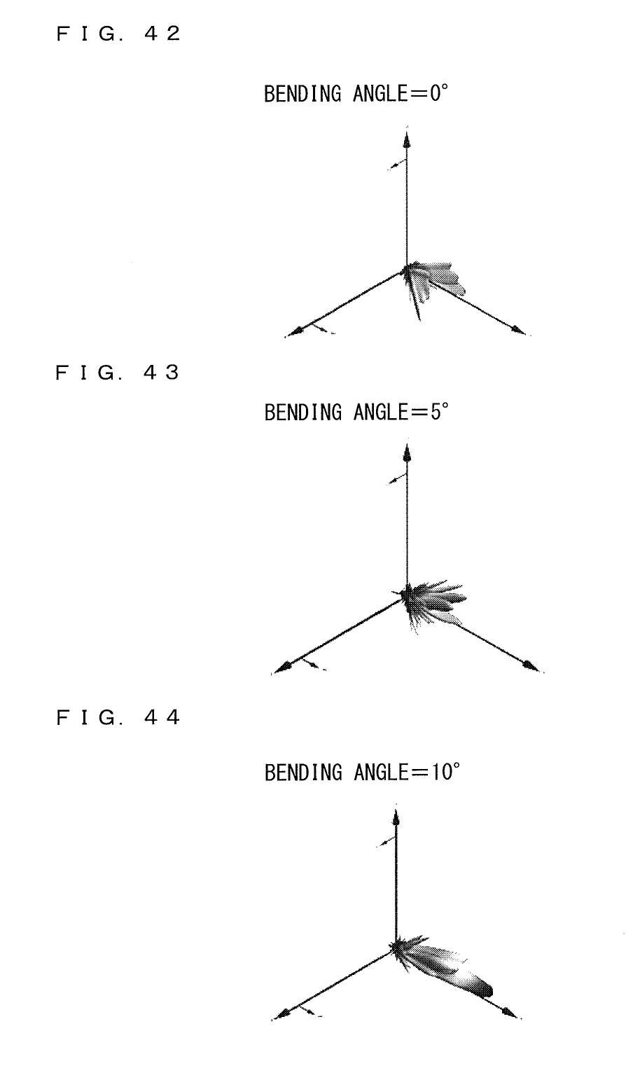

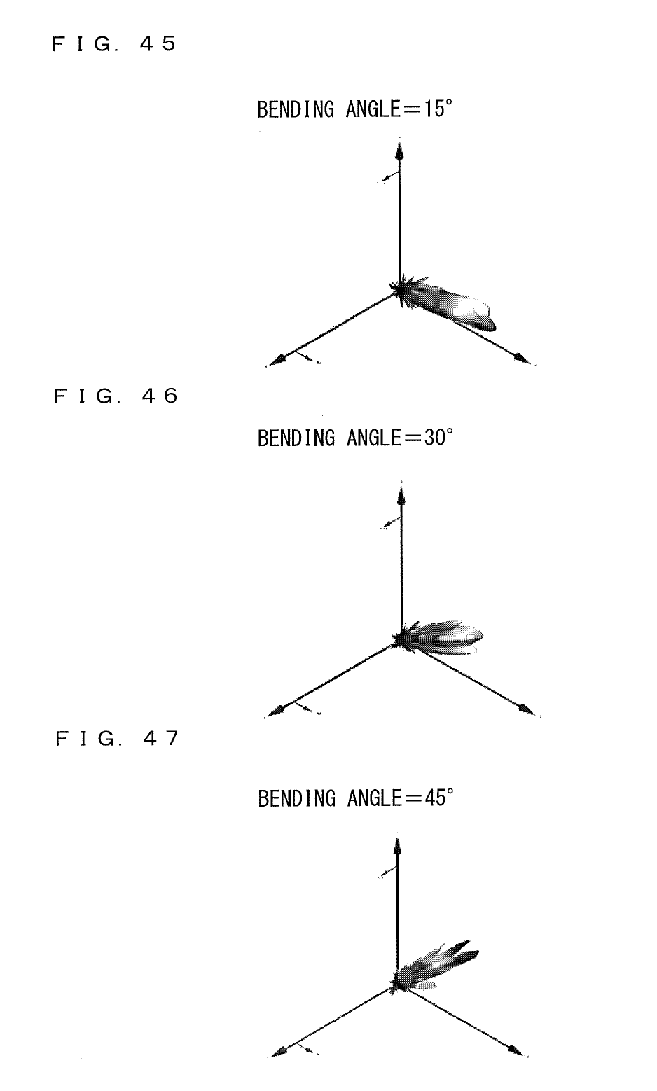

The directivity of the antenna module 1b obtained when non-porous PTFE is used as the material for the support body 25 was found by the electromagnetic field simulation. FIGS. 36 to 41 are diagrams respectively showing the results of the two-dimensional electromagnetic field simulation obtained when the bending angle φ is 0°, 5°, 10°, 15°, 30° and 45°. FIGS. 42 to 47 are diagrams respectively showing the results of the three-dimensional electromagnetic field simulation obtained when the bending angle φ is 0°, 5°, 10°, 15°, 30° and 45°. In FIGS. 42 to 47, a direction parallel to the one surface 25a of the support body 25 in the vertical plane (FIG. 27) is referred to as the X direction, and a direction parallel to the one surface 25a of the support body 25 and orthogonal to the X direction is referred to as the Y direction and a direction vertical to the one surface 25a of the support body 25 is referred to as the Z direction.

As shown in FIGS. 36 to 47, the bending angle φ of the antenna portion 6a is changed, whereby the radiation direction of the electromagnetic wave is changed. Further, the larger the bending angle φ is, the smaller the effect of the support body 25 on the electromagnetic wave is, so that better directivity of the electromagnetic wave is obtained. In particular, when the bending angle φ is not less than 5°, still better transmission characteristics are obtained as compared to a case in which the bending angle φ is 0°. When the bending angle φ is not less than 10°, even better transmission characteristics are obtained.

### (4) Modified Example of Antenna Body

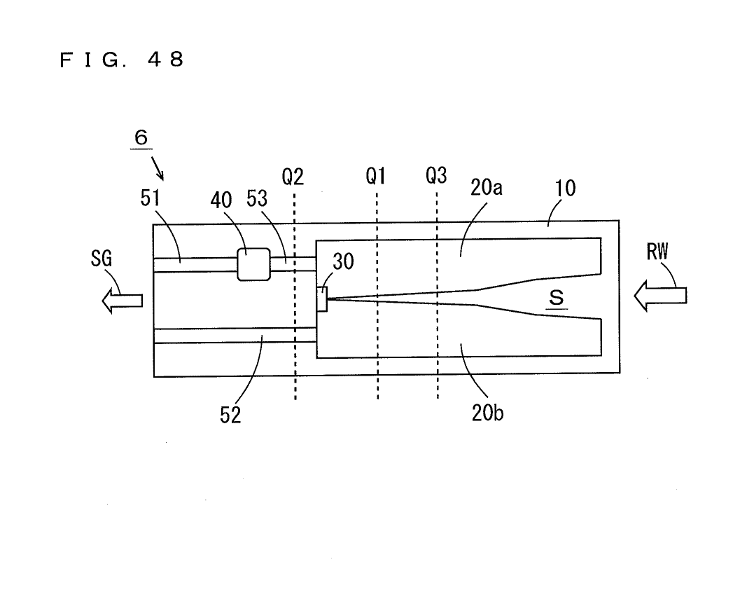

FIG. 48 is a schematic plan view showing the modified example of the antenna body 6 according to the above-mentioned first to third embodiments.

The antenna body 6 shown in FIG. 48 further includes signal wirings 51, 52, 53 and a low-pass filter 40 on the dielectric film 10. The signal wiring 51 is connected to the electrode 20a, and the signal wiring 52 is connected to the electrode 20b. The low-pass filter 40 is connected between the signal wiring 51 and the signal wiring 53. This low-pass filter 40 is formed of a meander wiring, a gold wire or the like, for example. The low-pass filter 40 passes only low frequency components of not more than a specific frequency (20 GHz, for example) that is a signal component in the gigahertz band.

The electrodes 20a, 20b, the low-pass filter 40 and the signal wirings 51, 52, 53 are formed on the dielectric film 10 in the common step using the subtractive method, the additive method or the semi-additive method, or by patterning a conductive material.

The electromagnetic wave RW includes the carrier wave having a frequency in the terahertz band and the signal wave having a frequency in the gigahertz band. This electromagnetic wave RW is received at the tapered slot S of the antenna body 6. A signal having a frequency in the gigahertz band is output to the signal wirings 51, 52 from the semiconductor device 30. At this time, part of a frequency component in the terahertz band may be transmitted from the electrodes 20a, 20b to the signal wirings 51, 52. In this case, the low-pass filter 40 blocks the frequency component in the terahertz band from passing. Thus, only the signal SG having a frequency (about 20 GHz, for example) in the gigahertz band is output to the signal wirings 51, 53.

In a case in which the antenna body 6 of FIG. 48 is used at the antenna module 1 of FIGS. 1 and 2, the antenna body 6 is bent along the dotted line Q1 that intersects with the electrodes 20a, 20b or the dotted line Q2 that intersects with the signal wirings 51, 52, for example, and the bent antenna body 6 is supported by the support body 5 of FIGS. 1 and 2. Further, when the antenna body 6 of FIG. 48 is used at the antenna module 1a of FIGS. 18 and 19, the antenna body 6 is bent in a U-shape along the dotted line Q3 that intersects with the electrodes 20a, 20b, for example, the one portion that uses the dotted line Q3 as a boundary is attached to the one surface 15a of the support body 15 of FIGS. 18 and 19, and the other portion is attached to the other surface 15b of the support body 15.

Further, in a case in which the antenna body 6 of FIG. 48 is used for the antenna module 1b of FIGS. 25 and 26, the one portion (a portion in which the electrodes 20a, 20b are not formed) of the dielectric film 10 that uses the dotted line Q2 as a boundary corresponds to the portion R1 of the dielectric film 10 of FIGS. 25 and 26, for example, and is attached to the one surface 25a of the support body 25. Further, the other portion (a portion in which the electrodes 20a, 20b are formed) of the dielectric film 10 with the dotted line Q2 used as a boundary corresponds to the portion R2 of the dielectric film 10 of FIGS. 25 and 26, and is bent so as to be inclined with respect to the one surface 25a of the support body 25. Further, a portion of the dielectric film 10 that corresponds to the portions R3, R4 of the dielectric film 10 of FIGS. 25 and 26 is provided anew, and a portion that corresponds to the portion R4 is attached to the one surface 25a of the support body 25.

### (5) Fourth Embodiment

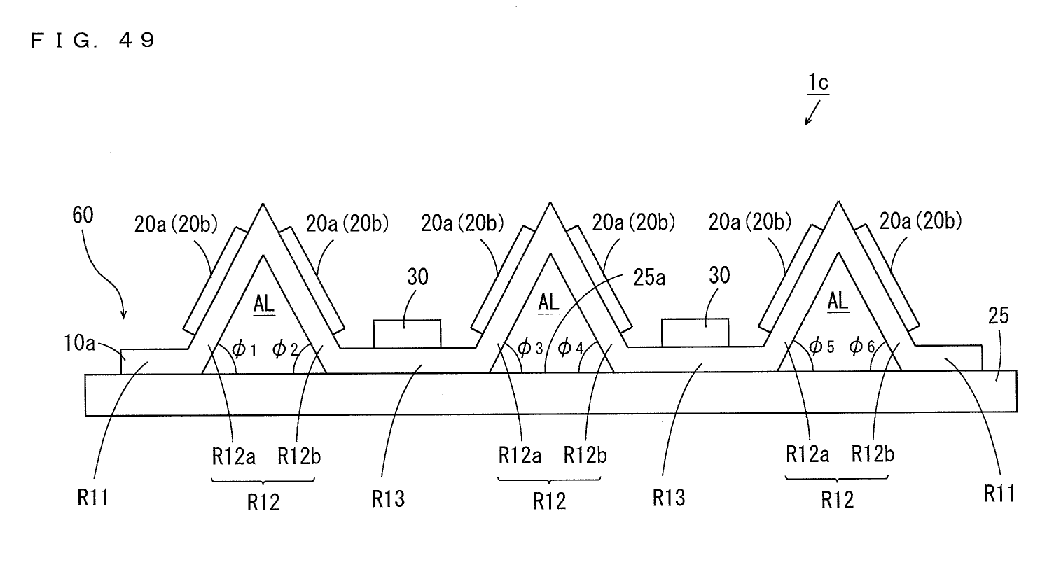

FIG. 49 is a schematic side view of the antenna module according to the fourth embodiment. Regarding the antenna module 1c of FIG. 49, difference from the antenna module 1b of FIGS. 25 and 26 will be described.

The antenna module 1c of FIG. 49 includes an antenna body 60 instead of the antenna body 6. The antenna body 60 includes a long-sized dielectric film 10a, a plurality of pairs (six pairs in the present example) of electrodes 20a, 20b and a plurality (two in the present example) of semiconductor devices 30.

The dielectric film 10a has a pair of fixing portions R11, a plurality (three in the present example) of electrode holding portions R12 and a plurality (two in the present example) of device mount portions R13. The pair of fixing portions R11 is provided at both ends of the dielectric film 10a, and the electrode holding portions R12 and the device mount portions R13 are alternately provided between the pair of fixing portions R11.

The back surface of each fixing portion R11 and each device mount portion R13 are attached to the one surface 25a of the support body 25. The semiconductor device 30 is mounted on the main surface of each device mount portion R13.

Each electrode holding portion R12 includes a pair of inclination portions R12a, R12b by being bent in an inverted V-shape. The bending angles φ₁ to φ₆ of the plurality of inclination portions R12a, R12b are set to be respectively different. The pair of electrodes 20a, 20b is formed on each of the main surfaces of the inclination portions R12a, R12b. Similarly to the above-mentioned first to third embodiments, each pair of electrodes 20a, 20b forms a tapered slot S. Each electrode 20a, 20b is electrically connected to the terminal 31a, 31b (FIG. 5 or 6) of any one of the semiconductor devices 30.

In the present embodiment, the electromagnetic wave can be received or transmitted by the electrodes 20a, 20b of each inclination portion R12a, R12b. In this case, because the bending angles φ₁ to φ₆ of the plurality of inclination portions R12a, R23b are respectively different, the electromagnetic wave can be radiated in a plurality of directions or the electromagnetic wave that arrives from a plurality of directions can be received. Further, it is possible to easily adjust the transmission/reception direction of the electromagnetic wave by adjusting the bending angle φ₁ to φ₆ of each inclination portion R12a, R12b.

Further, an air layer AL is formed between each electrode holding portion R12 in which the electrodes 20a, 20b are formed and the one surface 25a of the support body 25. Thus, the radiation efficiency of the electromagnetic wave having the used frequency can be sufficiently increased, and the transmission loss of the electromagnetic wave can be sufficiently reduced.

### (6) Other Embodiments

While the electrodes 20a, 20b are provided at the main surface of the dielectric film 10 in the above-mentioned first to fourth embodiments, the present invention is not limited to this. The electrodes 20a, 20b may be provided at the back surface of the dielectric film 10. Further, in the above-mentioned first to third embodiments, the plurality of pairs of electrodes 20a, 20b may be provided at the main surface or the back surface of the dielectric film 10.

While the semiconductor device 30 is mounted on the main surface of the dielectric film 10 in the above-mentioned first to fourth embodiments, the present invention is not limited to this. The semiconductor device 30 may be mounted on the back surface of the dielectric film 10. Further, in the above-mentioned first to third embodiments, the plurality of semiconductor devices 30 may be mounted on the main surface or the back surface of the dielectric film 10.

While the support bodies 5, 15, 25 are made of resin in the above-mentioned first to fourth embodiments, the present invention is not limited to this. When the support bodies 5, 15, 25 do not influence the electrodes 20a, 20b, the support bodies 5, 15, 25 may be formed of metal such as aluminum, copper or stainless. For example, a frame-shaped support body may be provided along the outer edge of the dielectric film 10 so as not to influence the electrodes 20a, 20b.

While the antenna module 1 that includes the tapered slot antenna is described in the above-mentioned embodiments, the present invention is not limited to these. The present invention is applicable to another planar antenna such as a patch antenna, a parallel slot antenna, a notch antenna or a microstrip antenna.

While preferred embodiments of the present invention have been described above, it is to be understood that variations and modifications will be apparent to those skilled in the art without departing the scope and spirit of the present invention. The scope of the present invention, therefore, is to be determined solely by the following claims.

### INDUSTRIAL APPLICABILITY

The present invention can be utilized for the transmission of an electromagnetic wave having a frequency in the terahertz band.

I/We claim:

1. An antenna module comprising:
a dielectric film that has first and second surfaces and is formed of resin to be bendable;
an electrode formed on at least one surface of the first and second surfaces of the dielectric film to be capable of receiving or transmitting an electromagnetic wave in a terahertz band;
a semiconductor device that is mounted on at least one surface of the first and second surfaces of the dielectric film to be electrically connected to the electrode, and is operable in the terahertz band; and
a support body that supports the dielectric film being bent.

2. The antenna module according to claim 1, wherein
the support body has a third surface,
the dielectric film includes
a first portion bonded to the third surface and
a second portion bent with respect to the first portion, and
at least part of the electrode is formed on the second portion.

3. The antenna module according to claim 2, wherein
the support body further has a fourth surface provided to be inclined by a predetermined angle with respect to the third surface, and
the second portion of the dielectric film is bonded to the fourth surface of the support body.

4. The antenna module according to claim 2, wherein
the support body further has a fourth surface provided to face away from the third surface,
the dielectric film further has a curved portion between the first portion and the second portion, and the second portion is bonded to the fourth surface of the support body.

5. The antenna module according to claim 4, wherein
the electrode is formed to extend on a first portion and a second portion.

6. The antenna module according to claim 2, wherein
the dielectric film further has a holder that holds the second portion at the support body such that a space is formed between the support body and the second portion.

7. The antenna module according to claim 6, wherein
the holder of the dielectric film includes
a third portion bent with respect to the second portion and
a fourth portion bent with respect to the third portion, and
the fourth portion is bonded to the third surface of the support body such that a space is formed between the second portion and the support body.

8. A method for manufacturing an antenna module comprising the steps of:
forming a bendable dielectric film with resin;
forming an electrode that is capable of receiving or transmitting an electromagnetic wave in a terahertz band on at least one surface of the first and second surfaces of the dielectric film;
mounting a semiconductor device operable in the terahertz band on at least one surface of the first and second surfaces of the dielectric film to be electrically connected to the electrode; and
bending the dielectric film that includes the electrode and the semiconductor device, and supporting the bent dielectric film by a support body.
